(19) United States
(12) Patent Application Publication
(10) Pub. No.: US 2013/0176619 A1
(43) Pub. Date: Jul. 11, 2013

(54) DISPLAY APPARATUS

(71) Applicant: Sony Corporation, Tokyo (JP)

(72) Inventors: Norifumi Hoshino, Tokyo (JP); Yoshihisa Sato, Saitama (JP); Yutaka Imai, Tokyo (JP)

(73) Assignee: Sony Corporation, Tokyo (JP)

(21) Appl. No.: 13/719,288

(22) Filed: Dec. 19, 2012

(30) Foreign Application Priority Data
Jan. 5, 2012 (JP) 2012-000624

(51) Int. Cl. G02B 27/22

(52) U.S. Cl. CPC G02B 27/22
USPC 359/463

(57) ABSTRACT

Embodiments of the invention provide an electronic device, such as a display apparatus (e.g., a naked-eye type stereoscopic image display apparatus). The electronic device comprises a display panel, comprising a plurality of pixels; and a parallax barrier, comprising a plurality of light transmission sections and a plurality of light blocking sections. The electronic device is operable to switch between a first setting, in which at least one of the plurality of light transmission sections has a first width, and a second setting, in which the at least one of the plurality of light transmission sections has a second width different than the first width.

### FIELD

The present disclosure relates to a display apparatus, and more particularly to a display apparatus which can display so-called naked-eye type stereoscopic images.

### BACKGROUND

In the related art, there are various stereoscopic image display apparatuses which realize stereoscopy by an image viewer viewing two images with parallax. The types of stereoscopic image display apparatus are largely classified into a glasses type where parallax images are separated by glasses and are input to the left and right eyes, and a naked-eye type (non-glasses type) where parallax images are input to the left and right eyes without using glasses. In addition, as a naked-eye type stereoscopic image display apparatus, a lenticular type stereoscopic image display apparatus in which a transmissive display panel (two-dimensional image display device) and a lenticular lens are combined, or a parallax barrier type stereoscopic image display apparatus in which a transmissive display panel and a parallax barrier are combined have been put into practical use.

The parallax barrier type stereoscopic image display apparatus is typically constituted by a transmissive display panel which includes a plurality of pixels disposed in a two-dimensional matrix in the horizontal direction (transverse direction) and the vertical direction (longitudinal direction), and a parallax barrier which includes a plurality of light transmission sections and light blocking sections substantially extending in the vertical direction and alternately arranged in the horizontal direction (for example, refer to JP-A-2005-086056). The transmissive display panel frequently includes a liquid crystal display device and is irradiated by a surface illumination device from a back surface, and each pixel functions as a kind of light shutter. In a case of performing color display using the transmissive display panel, typically, a pixel includes a plurality of subpixels, and each subpixel is surrounded by a black matrix.

### SUMMARY

However, in an image display apparatus, disclosed in JP-A-2005-086056, the width of the light transmission section (opening) in the parallax barrier conforms to the horizontal pixel pitch, and thus the width of the light transmission section is fixed. Therefore, for example, in a case where an image viewer makes a request for high image quality and high luminance of images displayed on the display apparatus, there is a problem in that neither may be appropriately handled nor supported.

Thus, it is desirable to provide a display apparatus having a configuration and a structure capable of appropriately handling or supporting both the case of a request for high image quality of images displayed on a display apparatus and the case of a request for high luminance thereof.

An embodiment of the present disclosure is directed to a display apparatus including a transmissive display panel that includes pixels arranged in a two-dimensional matrix in a first direction and a second direction different from the first direction; and a parallax barrier that separates images displayed on the transmissive display panel into images for a plurality of viewpoints, wherein the parallax barrier and the transmissive display panel are disposed so as to be opposite to each other with a space of a predetermined gap, wherein the parallax barrier includes a plurality of light transmission sections and light blocking sections which extend along an axial line parallel to the second direction or an axial line forming an acute angle with the second direction and are alternately arranged in the first direction, and wherein a width of the light transmission section in the first direction is variable.

In the display apparatus according to the embodiment, since the width of the light transmission section in the first direction is variable, in a case of making a request for high image quality of images displayed on the display apparatus, the width of the light transmission section may be small, and, in a case of making a request for high luminance, the width of the light transmission section may be large. Therefore, it is possible to appropriately handle and support both the case of making a request for high image quality of images displayed on the display apparatus and the case of making a request for high luminance thereof.

### BRIEF DESCRIPTION OF THE DRAWINGS

FIG. 1 is a schematic perspective view when a display apparatus according to a first embodiment is virtually separated;

FIGS. 2A and 2B are respectively a graph illustrating a simulation result of the moiré modulation depth in a back barrier type display apparatus, and a graph illustrating a simulation result of the moiré modulation depth in a front barrier type display apparatus;

FIGS. 3A and 3B are respectively a graph illustrating an example of the luminance profile obtained through calculation based on illumination calculation of a partial coherence theory, and a conceptual diagram of pixels, light transmission sections, and the like illustrating diffraction calculation including a shape of the pixel of the transmissive display panel and a shape of the light transmission section in a parallax barrier;

FIGS. 4A to 4L illustrate graphs indicating luminance profiles obtained through calculation based on illumination calculation of the partial coherence theory by using W₁/ND as a parameter in the back barrier type display apparatus;

FIGS. 5A to 5G illustrate graphs indicating luminance profiles obtained through calculation based on illumination calculation of the partial coherence theory by using W₁/ND as a parameter in the front barrier type display apparatus;

FIGS. 6A and 6B are respectively a graph illustrating a result of practically measuring the moiré modulation depth in the back barrier type display apparatus, and a graph illustrating a result of practically measuring the moiré modulation depth in the front barrier type display apparatus;

FIGS. 7A and 7B are graphs illustrating results of practically measuring how crosstalk varies when W₁=α·ND and W₁=2α·ND in the back barrier type display apparatus;

FIG. 8 is a schematic partial cross-sectional view of a liquid crystal display device forming the parallax barrier in the back barrier type display apparatus according to the first embodiment;

FIGS. 9A and 9B are schematic partial cross-sectional views of the liquid crystal display device illustrating operation states at W₁/ND=1.0 and W₁/ND=2.0 of the liquid crystal display device forming the parallax barrier in the display apparatus according to the first embodiment;

FIG. 10 is a schematic partial cross-sectional view of the liquid crystal display device forming a parallax barrier in a display apparatus according to a second embodiment;

FIGS. 11A and 11B are schematic partial cross-sectional views of the liquid crystal display device illustrating operation states at W₁/ND=1.0 and W₁/ND=2.0 of the liquid crystal display device forming the parallax barrier in the display apparatus according to the second embodiment;

FIG. 12 is a schematic perspective view when a display apparatus according to a third embodiment is virtually separated;

FIG. 13 is a schematic diagram illustrating a disposition relationship between the transmissive display panel and the parallax barrier in the display apparatus according to the third embodiment;

FIG. 14 is a schematic perspective view when a display apparatus according to a modified example of the third embodiment is virtually separated;

FIG. 15 is a schematic perspective view when a display apparatus according to a fourth embodiment is virtually separated;

FIG. 16 is a schematic partial cross-sectional view of a liquid crystal display device forming the parallax barrier in the back barrier type display apparatus according to the fourth embodiment;

FIGS. 17A and 17B are schematic partial cross-sectional views of the liquid crystal display device illustrating operation states at W₁/ND=α and W₁/ND=(α+1) of the liquid crystal display device forming the parallax barrier in the display apparatus according to the fourth embodiment;

FIG. 18 is a schematic partial cross-sectional view of a liquid crystal display device forming the parallax barrier in a display apparatus according to a fifth embodiment;

FIGS. 19A and 19B are schematic partial cross-sectional views of the liquid crystal display device illustrating operation states at W₁/ND=α and W₁/ND=(α+1) of the liquid crystal display device forming the parallax barrier in the display apparatus according to the fifth embodiment;

FIG. 20 is a schematic cross-sectional view of a portion of the display apparatus illustrating a disposition relationship between the transmissive display panel, the parallax barrier, and a surface illumination device in the display apparatus according to the first embodiment;

FIG. 21 is a schematic diagram illustrating a disposition relationship between viewpoints D1, D2, D3 and D4 in viewing regions illustrated in FIG. 1, the transmissive display panel, the parallax barrier, and the surface illumination device;

FIG. 22 is a schematic diagram illustrating a satisfied condition such that light beams from the pixels travel toward the viewpoints D1, D2, D3 and D4 of the central viewing region;

FIG. 23 is a schematic diagram illustrating a satisfied condition such that light beams from the pixels travel toward the viewpoints D1, D2, D3 and D4 of the left viewing region;

FIG. 24 is a schematic diagram illustrating an image viewed at the viewpoints D1, D2, D3 and D4 of the central viewing region;

FIG. 25 is a schematic diagram illustrating an image viewed at the viewpoints D1, D2, D3 and D4 of the left viewing region;

FIG. 26 is a schematic diagram illustrating an image viewed at the viewpoints D1, D2, D3 and D4 of the right viewing region;

FIG. 27 is a schematic cross-sectional view of a portion of the display apparatus illustrating a disposition relationship between the transmissive display panel, the parallax barrier, and the surface illumination device in the display apparatus according to the fourth embodiment;

FIGS. 28A and 28B are schematic diagrams illustrating a disposition relationship between the transmissive display panel and the parallax barrier, illustrating that moiré caused by a shape does not occur;

FIGS. 29A and 29B are schematic diagrams illustrating a disposition relationship between the transmissive display panel and the parallax barrier, illustrating the cause by which moiré caused by a shape occurs; and

FIG. 30 is a picture illustrating a state where moiré occurs in a display apparatus in the related art.

### DETAILED DESCRIPTION

Hereinafter, the present disclosure will be described based on embodiments with reference to the drawings, but the present disclosure is not limited to the embodiments, and various numerical values or materials in the embodiments are examples. In addition, the description will be made in the following order.

1. Description of overall display apparatus according to embodiments of present disclosure

2. First Embodiment (a display apparatus according to an embodiment of the present disclosure: back barrier type)

3. Second embodiment (a modification of the first embodiment)

4. Third embodiment (another modification of the first embodiment)

5. Fourth embodiment (a display apparatus according to an embodiment of the present disclosure: front barrier type)

6. Fifth embodiment (a modification of the fourth embodiment) and others

### 1. Description of Overall Display Apparatus According to Embodiments of Present Disclosure

In a display apparatus according to an embodiment of the present disclosure, the parallax barrier may have a liquid crystal display device at least including: a first substrate; a first electrode formed and patterned on the first substrate; a second substrate disposed so as to be opposite to the first substrate; a second electrode formed on the second substrate so as to be opposite to the first electrode; and a liquid crystal layer interposed between the first substrate and the second substrate. In addition, a form in which the parallax barrier has a liquid crystal display device is referred to as a “form in which the parallax barrier is constituted by a liquid crystal display device”.

In addition, in the form in which the parallax barrier is constituted by a liquid crystal display device, there may be further provided a surface illumination device that irradiates the transmissive display panel from a back surface, and, the parallax barrier may be disposed between the transmissive display panel and the surface illumination device. For convenience, a display apparatus having the disposition is referred to as a “back barrier type” display apparatus. In addition, in this case, when the width of the light transmission section in the first direction is W₁, the arrangement pitch of the pixels in the first direction is ND, and α is any coefficient, W₁ is preferably changed to two values of W₁=α·ND and the W₁=2α·ND, and further, 0.95≦α≦1.05 is preferably satisfied. In the form in which the parallax barrier is constituted by a liquid crystal display device, including the above-described preferable configuration, the haze value of the transmissive display panel is preferably 15% or less. In the back barrier type display apparatus, since the parallax barrier is not directly viewed by an image viewer who views the display apparatus, the quality of images displayed on the transmissive display panel is not lowered, and there is no problem of color unevenness occurring in the surface of the parallax barrier due to reflection of external light. In addition, since the transmissive display panel is irradiated by the surface illumination device via the parallax barrier, a problem hardly occurs in which reliability of the transmissive display panel is reduced due to irradiation light from the surface illumination device. In addition, it is not necessary to consider chromatic dispersion of the substrates forming the liquid crystal display device. Here, the haze value may be evaluated depending on the ratio of diffuse transmittance and total light transmittance of the transmissive display panel which are measured using an integral sphere type light transmittance measuring device. In addition, in relation to the haze value, refer to, for example, JIS K7136:2000. In order to set the haze value of the transmissive display panel to the above-described value, for example, a transparent film having such a haze value may be bonded to a surface facing an image viewer of the transmissive display panel. Alternatively, for example, by roughening the surface of a polarizer and dispersing granular substances having different refractive indices in a polarizer material, the haze value can be controlled. If the haze value is great, light from the transmissive display panel is scattered when traveling toward a viewing region, and there are cases where a reduction in the directivity of the image is visually recognized.

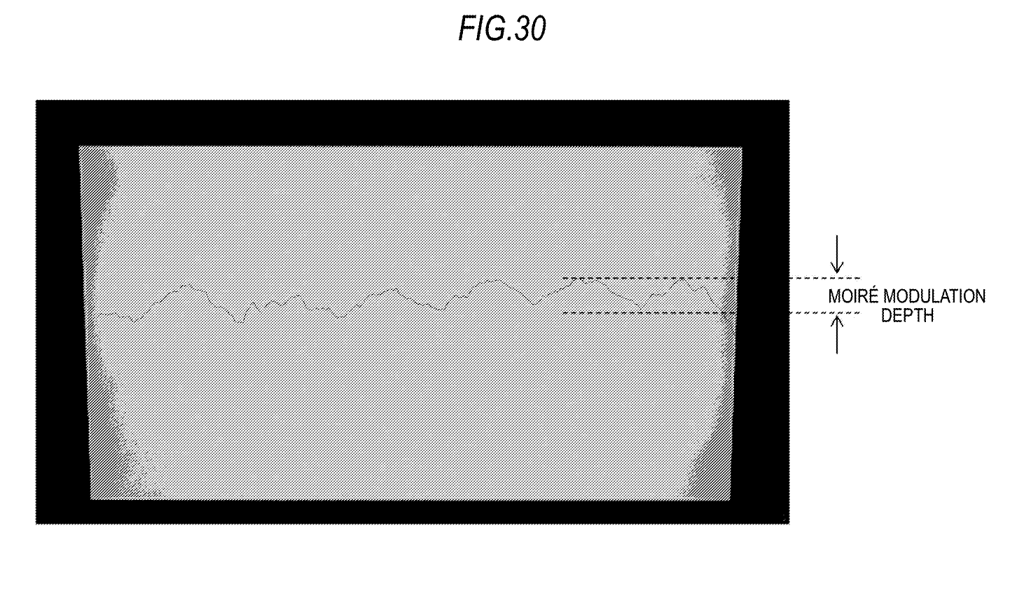

The light transmission sections of the parallax barrier and the black matrices of the transmissive display panel respectively have shapes which are regularly repeated. Therefore, moiré may occur in a state where the parallax barrier and the transmissive display panel are arranged in parallel. FIG. 30 is a picture illustrating a state where moiré occurs in a display apparatus in the related art. The moiré may be classified into moiré caused by shapes of the light transmission section of the parallax barrier and the black matrix of the transmissive display panel (for convenience, referred to as “moiré caused by a shape”) and moiré caused by a diffraction phenomenon of light (for convenience, “moiré caused by a diffraction phenomenon”).

As described above, 0.95≦α≦1.05 is satisfied in the back barrier type display apparatus, and thereby it is possible to suppress moiré caused by a diffraction phenomenon as well as moiré caused by a shape as described later.

Alternatively, in the form in which the parallax barrier is constituted by a liquid crystal display device, the parallax barrier may be disposed on a front surface of the transmissive display panel. A display apparatus having the disposition is referred to as a “front barrier type” display apparatus for convenience. In addition, in this case, when the width of the light transmission section in the first direction is W₁, an arrangement pitch of the pixels in the first direction is ND, and α is any coefficient equal to or more than 1, W₁ is preferably changed to two values of W₁=α·ND and the W₁=(α+1)·ND, and, further, 1<α<2 is preferably satisfied. In the form in which the parallax barrier is constituted by a liquid crystal display device, including the above-described preferable configuration, the haze value of the parallax barrier is preferably 15% or less. In order to set the haze value of the parallax barrier to the above-described value, for example, a transparent film having such a haze value may be bonded to the surface facing an image viewer of the parallax barrier. Alternatively, for example, by roughening the surface of a polarizer and dispersing granular substances having different refractive indices in a polarizer material, the haze value can be controlled.

In the form that the parallax barrier is constituted by the liquid crystal display device, including above-described various preferable configurations, a width WD₂₁ in the first direction of the first electrode forming the light blocking section is smaller than a width W₂ of the light blocking section in the first direction. Specifically, for example, 1 μm≦W₂−WD²¹≦15 μm may be exemplified. Further, a width WD₁₁ in the first direction of the first electrode forming the light transmission section is smaller than a width W₁ of the light transmission section in the first direction. Specifically, for example, 1 μm≦W₁−WD₁₁≦15 μm may be exemplified. In addition, in the form that the parallax barrier is constituted by the liquid crystal display device, including the preferable configuration, the width W₁ of the light transmission section in the first direction varies depending on the application state of a voltage to the first electrode and the second electrode. In this case, the liquid crystal layer of the liquid crystal display device forming the parallax barrier may be in a state (normally white) of transmitting light therethrough or in a state (normally black) of not transmitting light therethrough when a voltage is not applied to the first electrode and the second electrode.

Alternatively, in the form that the parallax barrier is constituted by the liquid crystal display device, including the above-described various preferable configurations, the first electrode may be formed in a region of the liquid crystal display device forming the light blocking section, the light transmission sections may include a region in which the first electrode is formed and a region in which the first electrode is not formed, which are arranged in parallel in the first direction, and a width WD₁₁ in the first direction of the first electrode forming the light transmission section is smaller than the width W₁ of the light transmission section in the first direction. Specifically, for example, 1 μm≦W₁−WD₁₁≦15 μm may be exemplified. In addition, in this case, the liquid crystal layer of the liquid crystal display device forming the parallax barrier is necessarily in a state (normally white) of transmitting light therethrough when a voltage is not applied to the first electrode and the second electrode. Further, in the form that the parallax barrier is constituted by the liquid crystal display device, including the preferable configuration, the width of the light transmission section in the first direction may vary depending on the application state of a voltage to the first electrode and the second electrode.

In addition, in the display apparatus according to the embodiment of the present disclosure, including the above-described various preferable forms and configurations, the light transmission sections and the light blocking sections of the parallax barrier may extend in parallel to the second direction, or an angle θ formed by the axial line of the parallax barrier and the second direction may be an acute angle. Particularly, when the arrangement pitch of the pixels in the second direction is ND₂, if a case where θ satisfies the following expression is considered, θ=tan⁻¹(ND₂/ND) is satisfied, and thereby the positional relationship between the pixels and the light transmission sections of the parallax barrier facing the pixels is the same along the axial line of the parallax barrier at all times. Therefore, it is possible to suppress occurrence of crosstalk when stereoscopic display is performed and to thereby realize a high image quality stereoscopic display. Alternatively, the light transmission sections forming the parallax barrier may be arranged in a straight line shape along the axial line of the parallax barrier, or the light transmission sections forming the parallax barrier may be arranged in a staircase pattern along the axial line of the parallax barrier.

In the display apparatus (hereinafter, collectively simply referred to as a “display apparatus or the like according to an embodiment of the present disclosure” in some cases) according to an embodiment of the present disclosure, including the above-described various preferable forms and configurations, the transmissive display panel may include, for example, a liquid crystal display panel. A configuration, a structure or a driving method of the liquid crystal display panel is not particularly limited. The transmissive display panel may perform monochrome display or color display. In addition, a passive matrix type or an active matrix type may be employed. In each embodiment described later, an active matrix type liquid crystal display panel is used as the transmissive display panel. The liquid crystal display panel includes, for example, a front panel having a transparent first electrode, a rear panel having a transparent second electrode, and a liquid crystal material disposed between the front panel and the rear panel. In addition, a so-called transflective liquid crystal display panel of which each pixel has a reflective region and a transmissive region is also included in the transmissive display panel in the display apparatus or the like according to the embodiment of the present disclosure.

Here, more specifically, the front panel includes, for example, a first substrate constituted by a glass substrate, the transparent first electrode (also called a common electrode, and, made of, for example, ITO (Indium Tin Oxide)) provided on the inner surface of the first substrate, and a polarization film provided on an outer surface of the first substrate. In addition, in a color liquid crystal display panel, the front panel has a configuration in which a color filter coated by an overcoat layer made of an acryl based resin or an epoxy based resin is provided on the inner surface of the first substrate, and the transparent first electrode is formed on the overcoat layer. An alignment layer is formed on the transparent first electrode. Disposition patterns of the color filter may include a delta arrangement, a stripe arrangement, a diagonal arrangement, and a rectangular arrangement.

On the other hand, more specifically, the rear panel includes, for example, a second substrate constituted by a glass substrate, a switching element formed on an inner surface of the second substrate, the transparent second electrode (also called a pixel electrode, and, made of, for example, ITO) of which conduction and non-conduction are controlled by the switching element, and a polarization film provided on an outer surface of the second substrate. An alignment layer is formed on the entire surface including the transparent second electrode. A variety of members or liquid crystal materials forming the transmissive liquid crystal display panel may include well-known members or materials. In addition, as the switching element, a three-terminal element such as a thin film transistor (TFT), an MIM (Metal Insulator Metal) element, a varistor element, or a two-terminal element such as a diode may be exemplified.

In addition, in the color liquid crystal display panel, a region which is an overlapping region of the transparent first electrode and the transparent second electrode and includes a liquid crystal cell corresponds to a subpixel. Further, a red light emitting subpixel forming each pixel includes a combination of a related region and a color filter transmitting red therethrough, a green light emitting subpixel includes a combination of a related region and a color filter transmitting green therethrough, and a blue light emitting subpixel includes a combination of a related region and a color filter transmitting blue therethrough. A disposition pattern of the red light emitting subpixel, the green light emitting subpixel, and the blue light emitting subpixel conforms to a disposition pattern of the above-described color filters. Further, each pixel may include a set of subpixels obtained by adding one kind or a plurality of kinds of subpixels to the three kinds of subpixels (for example, a set of subpixels obtained by adding a subpixel emitting white light in order to increase the luminance, a set of subpixels obtained by adding a subpixel emitting a complementary color in order to enlarge the color gamut, a set of subpixels obtained by adding a subpixel emitting yellow in order to enlarge the color gamut, and a set of subpixels obtained by adding subpixels emitting yellow and cyan in order to enlarge the color gamut). In addition, in this configuration, each subpixel corresponds to a “pixel” in the transmissive display panel of the display apparatus or the like according to the embodiment of the present disclosure.

In the front barrier type display apparatus, the transmissive display panel may further include, for example, an electroluminescence display panel or a plasma display panel.

When the number M×N of pixels arranged in a two-dimensional matrix is denoted by (M,N), as values of (M,N), specifically, in addition to VGA (640,480), S-VGA (800,600), XGA (1024,768), APRC (1152,900), S-XGA (1280,1024), U-XGA (1600,1200), HD-TV (1920,1080), and Q-XGA (2048,1536), some of image display resolutions such as (1920,1035), (720,480), and (1280,960) may be exemplified, and the number thereof is not limited to these values.

The configuration and structure of the liquid crystal display device forming the parallax barrier are equal or similar to the configuration and structure of the liquid crystal display panel forming the transmissive display panel except for the configuration and structure of the pixels and the subpixels. Here, since the liquid crystal display device forming the parallax barrier preferably functions as a so-called light shutter, a switching element or a color filter which is necessary in a typical liquid crystal display device which displays images is not necessary, it is possible to simplify the configuration and structure, and it is possible to secure high reliability and long life. In addition, since a black matrix needs not be formed, it is possible to simplify the manufacturing process for the entire liquid crystal display device. The transmissive display panel and the first substrate of the liquid crystal display device may face each other, or the transmissive display panel and the second substrate of the liquid crystal display device may face each other.

The surface illumination device (backlight) in the display apparatus or the like according to the embodiment of the present disclosure may include a well-known surface illumination device. That is to say, the surface illumination device may be a direct surface light source device, or an edge light type (also called a sidelight type) surface light source device. Here, the direct surface light source device includes, for example, a light source provided in a casing, a reflection member which is disposed in a casing portion located under the light source and reflects emitted light from the light source upwards, and a diffusion plate which is installed at a casing opening located above the light source and diffuses and transmits emitted light from the light source and reflected light from the reflection member therethrough. On the other hand, the edge light type surface light source device includes, for example, a light guide plate and a light source disposed on the side surface of the light guide plate. In addition, a reflection member is disposed under the light guide plate, and a diffusion sheet and a prism sheet are disposed above the light guide plate. The light source includes, for example, a cold cathode fluorescent lamp, and emits white light. Alternatively, the light source includes, for example, a light emitting device such as an LED or a semiconductor laser device.

A driver which drives the surface illumination device or the transmissive display panel may include various circuits such as, for example, an image signal processing unit, a timing control unit, a data driver, a gate driver, and a light source control unit. They may include well-known circuit elements.

In the display apparatus according to the embodiment of the present disclosure, stereoscopic images and two-dimensional images can be displayed, or different images can be displayed when the display apparatus is viewed from different angles. In addition, in this case, image data sent to the display apparatus may be image data which is necessary for displaying stereoscopic images, or image data which is necessary for displaying two-dimensional images.

Changing in the width W₁ of the light transmission section may be performed, for example, by providing a changeover switch in the display apparatus and an image viewer operating the changeover switch, or changing in the width W₁ of the light transmission section may be automatically performed by the image signal processing unit of the display apparatus analyzing image data to be displayed. In a case where great importance is placed on image quality and great importance is not placed on luminance of an image, the width W₁ of the light transmission section is made small [W₁=α·ND], and, in a case where great importance is placed on luminance and great importance is not placed on image quality, the width W₁ of the light transmission section is made large [W₁=2α·ND or W₁=(α+1)·ND]. Here, in a case where the width W₁ of the light transmission section is large, when stereoscopic images having a great stereoscopic effect are displayed on the transmissive display panel, although only slight, stereoscopic images may be doubled or some blurring may occur in the stereoscopic images. Therefore, in a case where the image signal processing unit analyzes a depth map of image data to be displayed and determines that stereoscopic images having a great stereoscopic effect are displayed on the transmissive display panel on the basis of the analysis result, the image signal processing unit may perform changing so as to decrease the width W₁ of the light transmission section, and, conversely, in a case where the image signal processing unit determines that stereoscopic images having a small stereoscopic effect are displayed on the transmissive display panel, the image signal processing unit may perform changing so as to increase the width W₁ of the light transmission section. In addition, in this case, there is concern of luminance of the transmissive display panel varying greatly due to the frequent changing in the width W₁ of the light transmission section, but it is possible to suppress luminance of the transmissive display panel from greatly varying by appropriately controlling (an operation control of a light source of the surface illumination device) an amount of light emitted from the surface illumination device.

### 2. First Embodiment

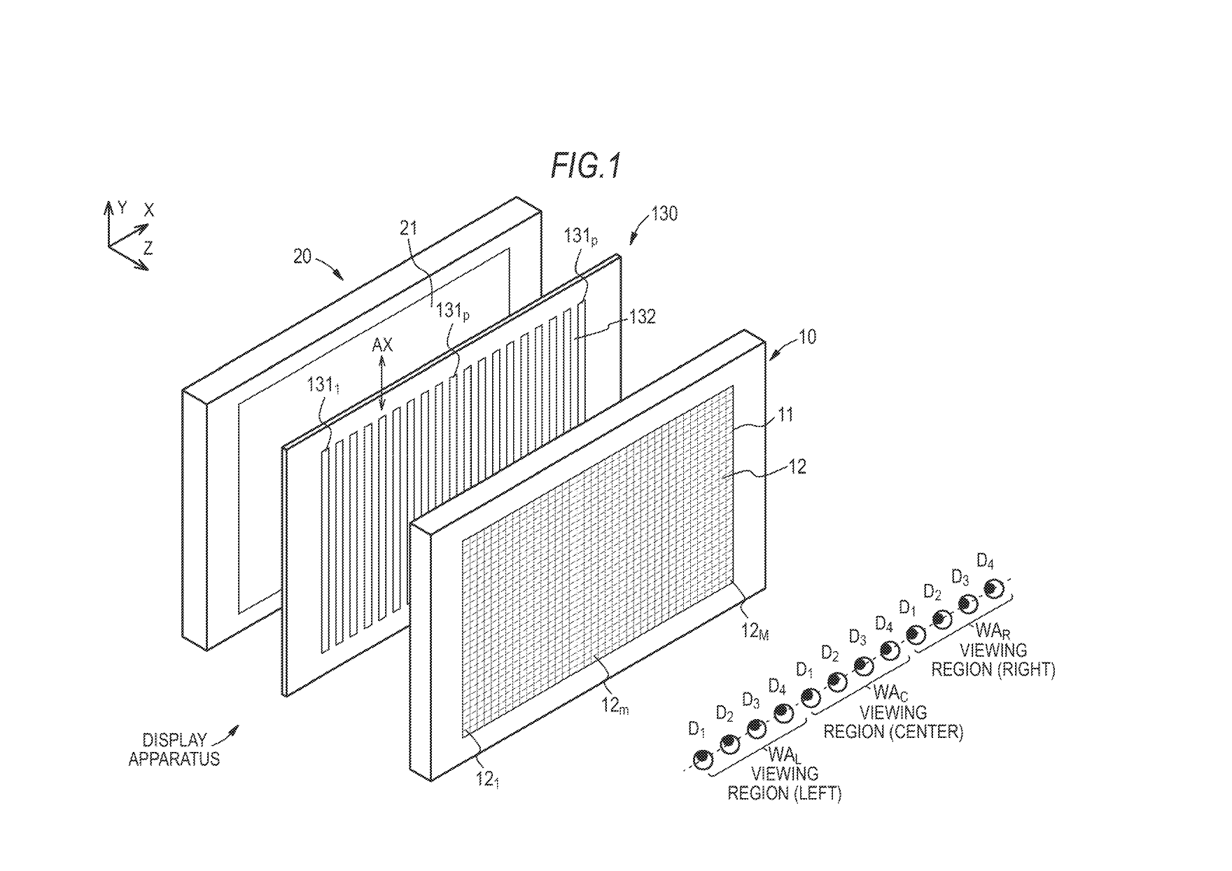

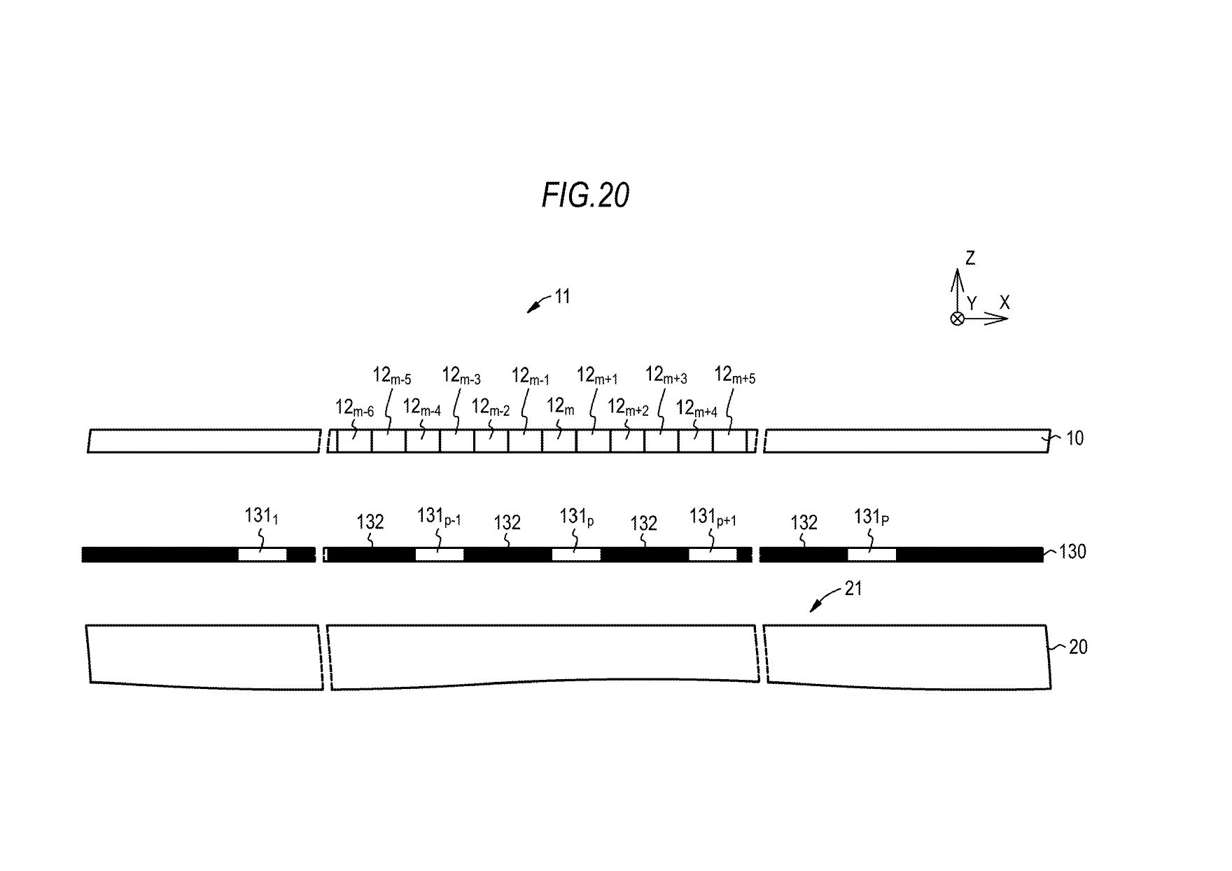

The first embodiment relates to a display apparatus according to the present disclosure, and more particularly to a so-called back barrier type display apparatus. FIG. 1 is a schematic perspective view when the display apparatus according to the first embodiment is virtually separated, and FIG. 20 is a schematic cross-sectional view of a portion of the display apparatus illustrating a disposition relationship between a transmissive display panel 10, a parallax barrier 130, and a surface illumination device 20 in the display apparatus according to the first embodiment.

As illustrated in FIG. 1, the display apparatus according to the first embodiment includes the transmissive display panel 10 having pixels 12 which are arranged in a two dimensional matrix in a first direction (in the embodiment, specifically, the horizontal direction, or the X direction) and in a second direction (in the embodiment, specifically, the vertical direction or the Y direction) different from the first direction, and the parallax barrier 130 which separates images displayed on the transmissive display panel 10 into images for a plurality of viewpoints.

The transmissive display panel 10 includes an active matrix color liquid crystal display panel. A display region 11 of the transmissive display panel 10, M pixels 12 are arranged in the first direction (the horizontal direction or the X direction), and N pixels 12 are arranged in the second direction (the vertical direction or the Y direction). An m-th (where m=1, 2, . . . , and M) pixel 12 is indicated by the pixel 12ₘ. Each of the pixels 12 includes a red light emitting subpixel, a green light emitting subpixel, and a blue light emitting subpixel. The transmissive display panel 10 includes a front panel on the viewing region side, a rear panel on the parallax barrier side, and a liquid crystal material disposed between the front panel and the rear panel. In addition, for simplicity of the drawings, in FIGS. 1, 12, 14 and 15, the transmissive display panel 10 is illustrated as a single panel.

The liquid crystal display panel forming the transmissive display panel 10 includes a front panel having a transparent first electrode, a rear panel having a transparent second electrode, and a liquid crystal material disposed between the front panel and the rear panel. In addition, the front panel includes a first substrate constituted by a glass substrate, the transparent first electrode provided on an inner surface of the first substrate, and a polarization film provided on an outer surface of the first substrate. In addition, a color filter coated by an overcoat layer made of an acryl based resin or an expoxy based resin is provided on the inner surface of the first substrate, and the transparent first electrode is formed on the overcoat layer. An alignment layer is formed on the transparent first electrode. On the other hand, the rear panel includes a second substrate constituted by a glass substrate, a switching element formed on an inner surface of the second substrate, the transparent second electrode of which conduction and non-conduction are controlled by the switching element, and a polarization film provided on an outer surface of the second substrate. An alignment layer is formed on the entire surface including the transparent second electrode. Further, a region which is an overlapping region of the transparent first electrode and the transparent second electrode and includes a liquid crystal cell corresponds to a subpixel.

In addition, the display apparatus according to the first embodiment includes the surface illumination device 20 which irradiates the transmissive display panel 10 from the back surface. Further, the parallax barrier 130 is disposed between the transmissive display panel 10 and the surface illumination device 20.

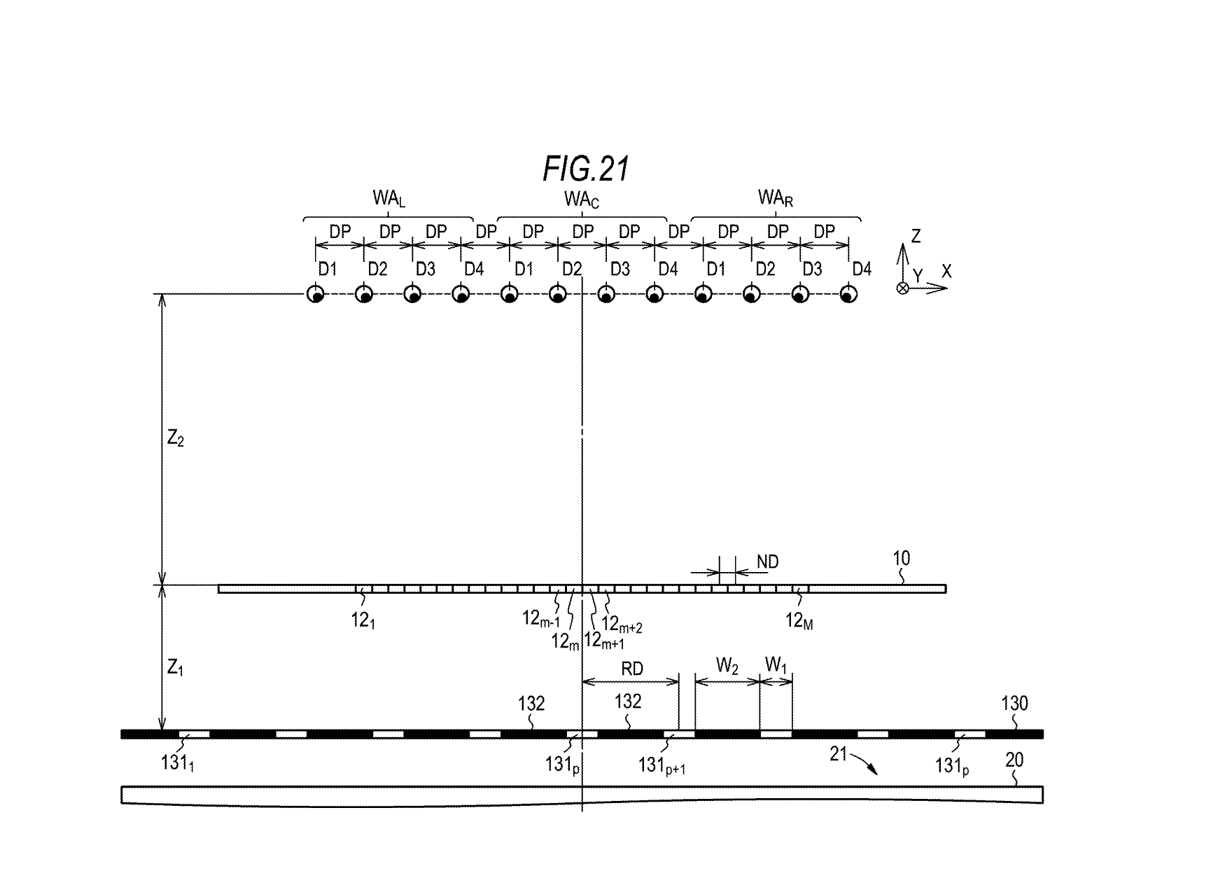

In other words, the parallax barrier 130 and the transmissive display panel 10 are disposed so as to be opposite to each other with a space of a predetermined gap (Z₁). Specifically, in the display apparatus according to the first embodiment, the transmissive display panel 10 and the parallax barrier 130 are disposed so as to be spaced apart from each other. The space may be taken up by an air layer or a vacuum layer, or may be taken up by a transparent member (not illustrated), and the optical path length may become Z₁ in consideration of a refractive index of a material taking up the space. In addition, the parallax barrier 130 includes a plurality of light transmission sections 131 and light blocking sections 132 which extend along an axial line AX parallel to the second direction (the vertical direction or the Y direction) or an axial line AX forming an acute angle with the second direction (the vertical direction or the Y direction) and are alternately arranged in parallel. In addition, in the first embodiment, the light transmission sections 131 and the light blocking sections 132 extend in parallel to the second direction (the vertical direction or the Y direction). That is to say, the axial line AX of the parallax barrier 130 is parallel to the second direction (the vertical direction or the Y direction). The width W₁ of the light transmission section 131 in the first direction is variable. The light transmission sections (openings) 131 are disposed in a plurality (P) in the first direction (the horizontal direction or the X direction). A p-th (where p=1, 2, . . . , and P) light transmission section 131 is indicated by a light transmission section 131ₚ. The relationship between “P” and the above-described “M” will be described later with reference to FIGS. 21, 22 and 23.

The surface illumination device 20 includes, for example, a direct surface light source device. Diffused light which is emitted from a light source including LEDs and passes through a diffusion plate and the like is emitted from a light emitting surface 21 and is applied to the back surface of the transmissive display panel 10. If some of the light of the surface illumination device 20 is blocked by the parallax barrier 130, images displayed by the transmissive display panel 10 are separated into images for a plurality of viewpoints.

In addition, the distance between the parallax barrier 130 and the transmissive display panel 10, the arrangement pitch (hereinafter, simply referred to as a “pixel pitch” in some cases) of the pixels 12 in the X direction, and a pitch (hereinafter, simply referred to as a “light transmission section pitch”) of the light transmission sections 131 in the X direction are set to satisfy conditions capable of viewing preferable stereoscopic images in a viewing region defined in the specification of a display apparatus. Hereinafter, these conditions will be described in detail.

In the first embodiment, a description will made assuming that the number of viewpoints of images displayed on the display apparatus is four of viewpoints D1, D2, D3 and D4 in the respective viewing regions WA_{L}, WA_{C} and WA_{R} illustrated in FIG. 1. However, the present disclosure is not limited thereto, and the number of viewing regions or the number of viewpoints may be appropriately set according to designs of a display apparatus.

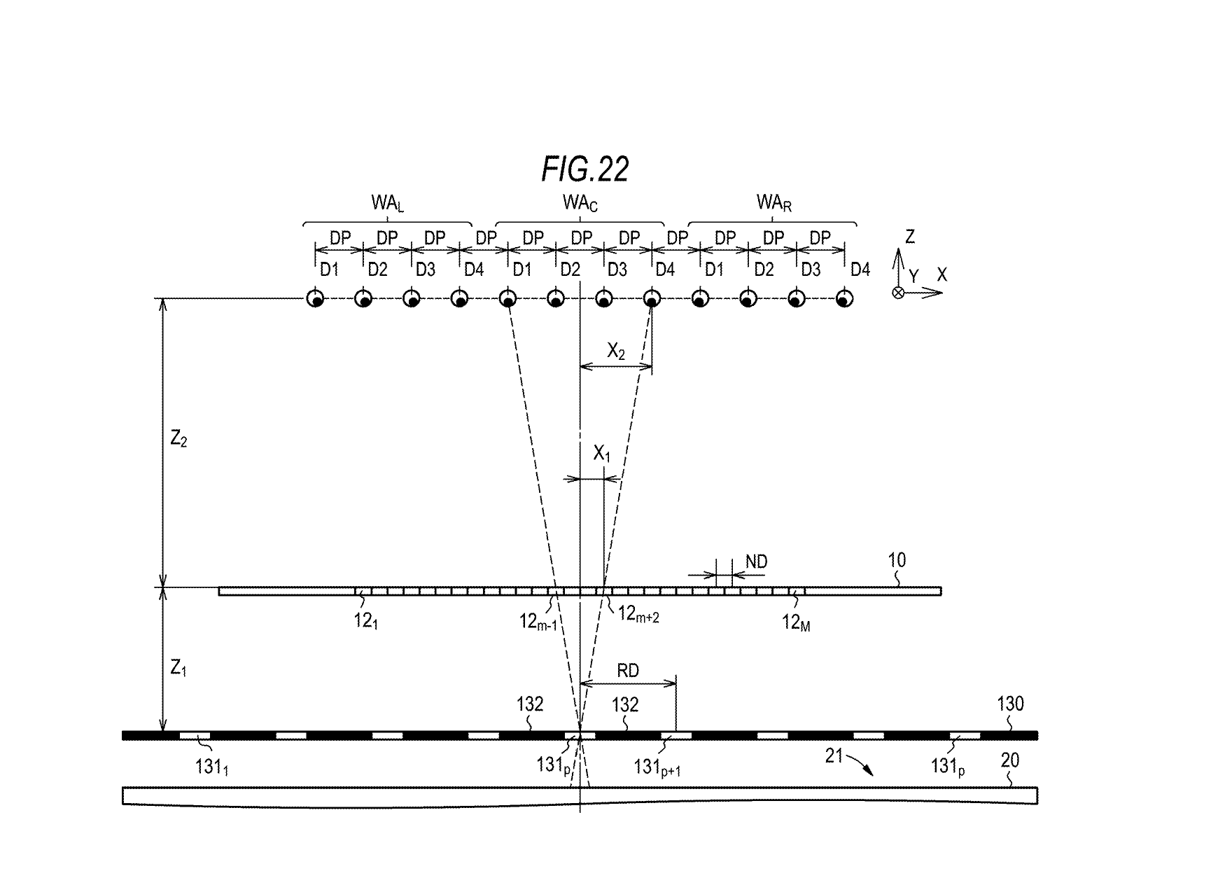

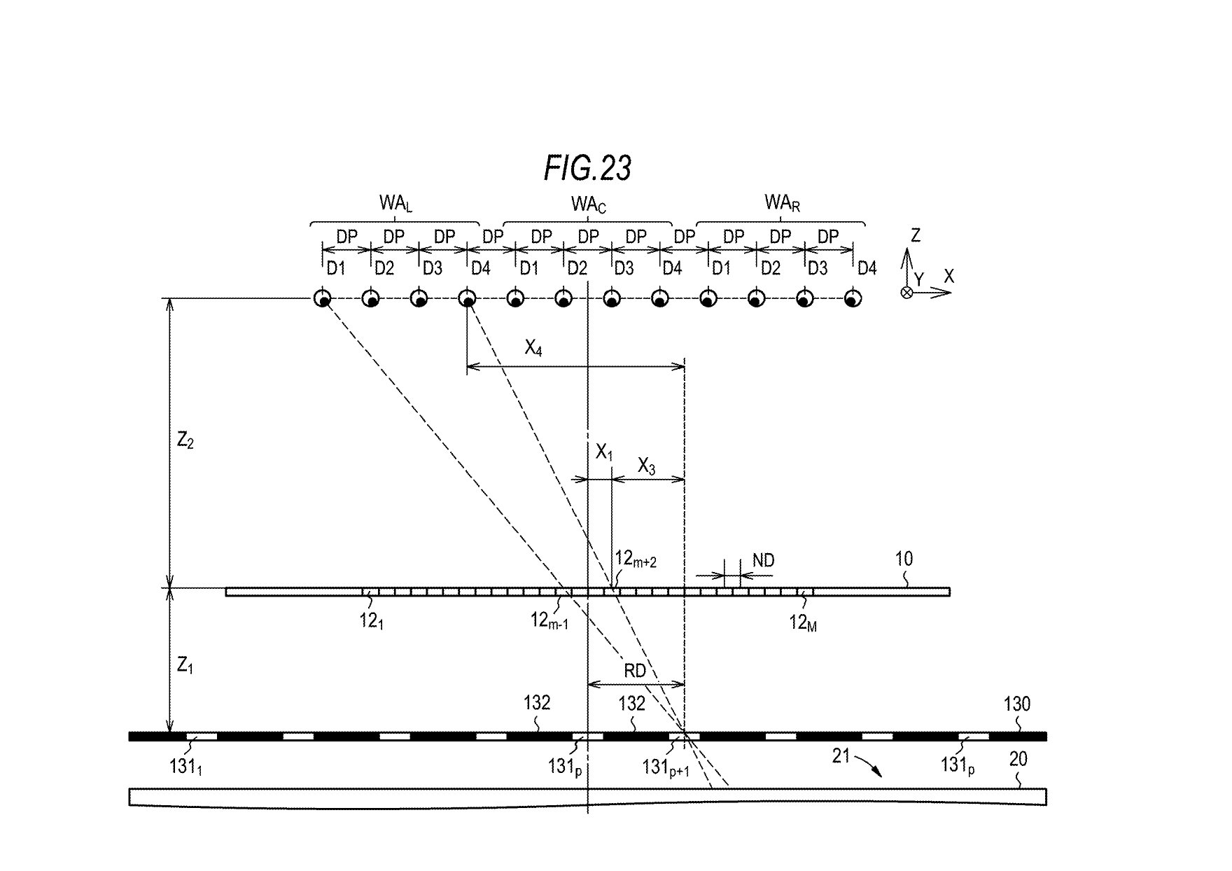

FIG. 21 is a schematic diagram illustrating a disposition relationship between the viewpoints D1, D2, D3 and D4 in the viewing regions WA_{L}, WA_{C} and WA_{R} illustrated in FIG. 1, the transmissive display panel 10, the parallax barrier 130, and the surface illumination device 20. FIG. 22 is a schematic diagram illustrating a satisfied condition such that light beams from the pixels 12 travel toward the viewpoints D1, D2, D3 and D4 of the central viewing region WA_{C}. Further, FIG. 23 is a schematic diagram illustrating a satisfied condition such that light beams from the pixels 12 travel toward the viewpoints D1, D2, D3 and D4 of the left viewing region WA_{L}.

For convenience of description, it is assumed that the light transmission sections 131 are arranged in parallel in an odd number in the X direction, and the p-th light transmission section 131ₚ is located at the center between the light transmission section 131₁ and the light transmission section 131_{P}. In addition, it is assumed that the boundary between the m-th pixel 12ₘ and the (m+1)-th pixel 12ₘ₊₁, and the midpoint between the viewpoints D2 and D3 in the viewing region WA_{C} are located on a virtual straight line which extends through the center of the light transmission section 131ₚ in the Z direction. The pixel pitch is indicated by “ND” (unit: mm), and the light transmission section pitch is indicated by “RD” (unit: mm). In addition, the distance between the light transmission sections 131 and the transmissive display panel 10 is indicated by “Z₁” (unit: mm), and the distance between the transmissive display panel 10 and the viewing regions WA_{L}, WA_{C} and WA_{R} is indicated by “Z₂” (unit: mm). Further, the distance between the adjacent viewpoints in the viewing regions WA_{L}, WA_{C} and WA_{R} is indicated by “DP” (unit: mm).

When the width of the light transmission section 131 is W₁, and the width of the light blocking section 132 is W₂, there is a relationship of RD=W₁+W₂ between the light transmission section pitch RD, the width W₁ of the light transmission section 131, and the width W₂ of the light blocking section 132.

A condition is examined in which the respective light beams from the light transmission section 131ₚ passing through the pixels 12ₘ₋₁, 12ₘ, 12ₘ₊₁ and 12ₘ₊₂ travel toward the viewpoints D1, D2, D3 and D4 of the central viewing region WA_{C}. For convenience of description, the description will be made assuming that the width W₁ of the light transmission section 131 is sufficiently small, and attention is paid to an orbit of light passing through the center of the light transmission sections 131. By using the virtual straight line extending through the center of the light transmission section 131ₚ in the Z direction as a reference, the distance to the center of the pixel 12ₘ₊₂ is indicated by X₁, and the distance to the viewpoint D4 of the central viewing region WA_{C} is indicated by X₂. When light from the light transmission section 131ₚ passes through the pixel 12ₘ₊₂ and travels toward the viewpoint D4 of the viewing region WA_{C}, a condition indicated by the following Expression (1) is satisfied from a geometric similarity relation.

Z₁/X₁=(Z₄+Z₂)/X₂ (1)

Here, since X₁=1.5×ND and X₂=1.5×DP, if they are reflected, Expression (1) may be expressed as in the following Expression (1′).

Z₁/(1.5×ND)=(Z₁+Z₂)/(1.5×DP) (1′)

In addition, if Expression (1′) is satisfied, it is geometrically clear that light beams from the light transmission section 131ₚ passing through the pixels 12ₘ₋₁, 12ₘ and 12ₘ₊₁ respectively travel toward the viewpoints D1, D2 and D3 of the viewing region WA_{C}.

Next, a condition is examined in which the respective light beams from the light transmission section 131ₚ₊₁ passing through the pixels 12ₘ₋₁, 12ₘ, 12ₘ₊₁ and 12ₘ₊₂ travel toward the viewpoints D1, D2, D3 and D4 of the left viewing region WA_{L}.

By using the virtual straight line extending through the center of the light transmission section 131ₚ₊₁ in the Z direction as a reference, the distance to the center of the pixel 12ₘ₊₂ is indicated by X₃, and the distance to the viewpoint D4 of the left viewing region WA_{L} is indicated by X₄. In order for light from the light transmission section 131ₚ₊₁ to pass through the pixel 12ₘ₊₂ and travel toward the viewpoint D4 of the viewing region WA_{L}, a condition indicated by the following Expression (2) is satisfied from a geometric similarity relation.

Z₁/X₃=(Z₁+Z₂)/X₄ (2)

Here, since X₃=RD−X₁=RD−1.5×ND and X₄=RD+2.5×DP, if they are reflected, Expression (2) may be expressed as in the following Expression (2′).

Z₁/(RD−1.5×ND)=(Z₁+Z₂)/(RD+2.5×DP) (2′)

In addition, if Expression (2′) is satisfied, it is geometrically clear that light beams from the light transmission section 131ₚ₊₁ passing through the pixels 12ₘ₋₁, 12ₘ and 12ₘ₊₁ respectively travel toward the viewpoints D1, D2 and D3 of the viewing region WA_{L}.

In addition, a condition in which the respective light beams from the light transmission section 131ₚ₋₁ passing through the pixels 12ₘ₋₁, 12ₘ, and 12ₘ₊₂ travel toward the viewpoints D1, D2, D3 and D4 of the right viewing region WA_{R} is the same as a case of reversing FIG. 23 with respect to the Z direction, and thus description thereof will be omitted.

Values of the distance Z₂ and the distance DP are set to predetermined values on the basis of the specification of the display apparatus. In addition, a value of the pixel pitch ND is defined by a structure of the transmissive display panel 10. From Expressions (1′) and (2′), the following Expressions (3) and (4) can be obtained with respect to the distance Z₁ and the light transmission section pitch RD.

Z₁=Z₂×ND/(DP−ND) (3)

RD=4×DP×ND/(DP−ND) (4)

In the above-described example, a value of the light transmission section pitch RD is substantially four times the value of the pixel pitch ND. Therefore, the above-described “M” and “P” have a relationship of M≅P×4. In addition, the distance Z₁ or the light transmission section pitch RD is set to satisfy the above-described conditions, and images for a predetermined viewpoint can be viewed at the respective viewpoints D1, D2, D3 and D4 of the viewing regions WA_{L}, WA_{C} and WA_{R}. For example, if the pixel pitch ND of the transmissive display panel 10 is 0.100 mm, the distance Z₂ is 1500 mm, and the distance DP is 65.0 mm, the distance Z₁ is 2.31 mm, and the light transmission section pitch RD is 0.400 mm.

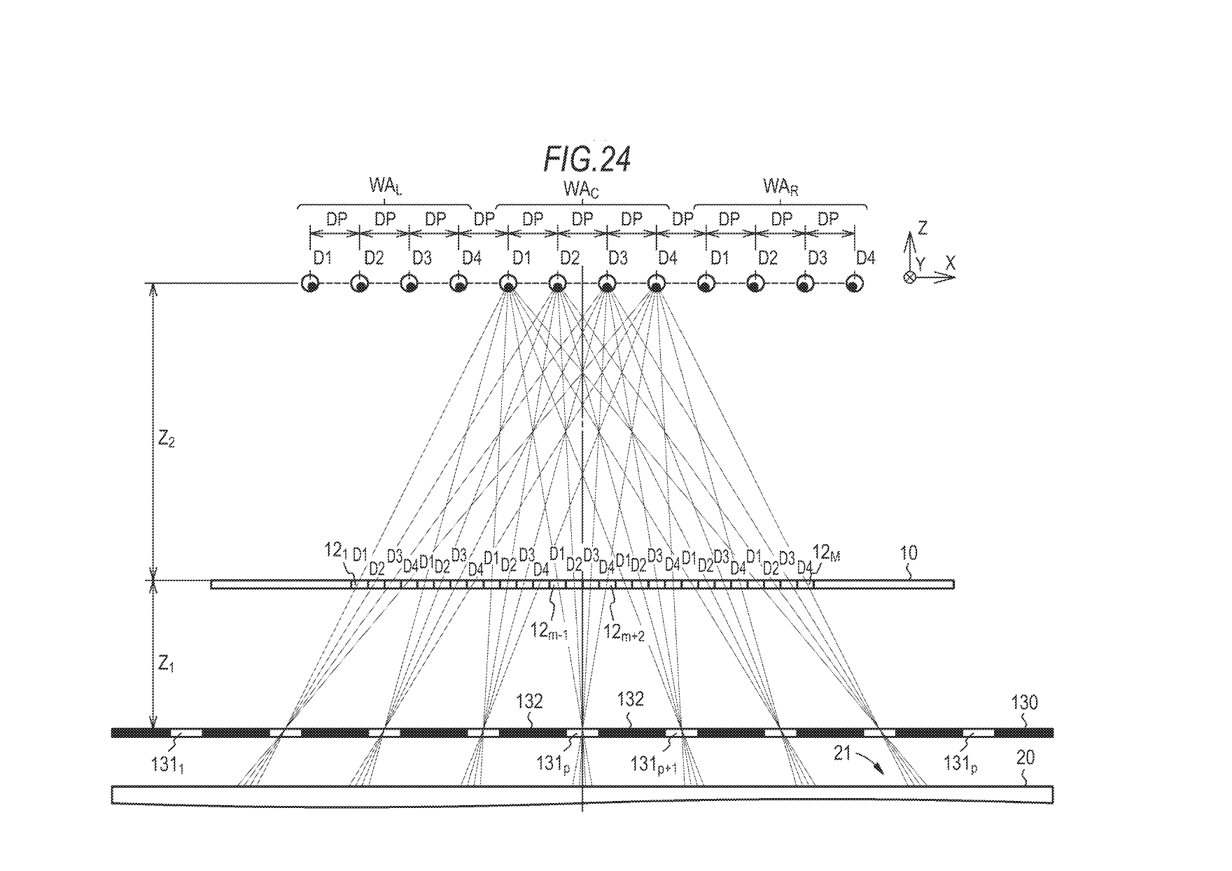

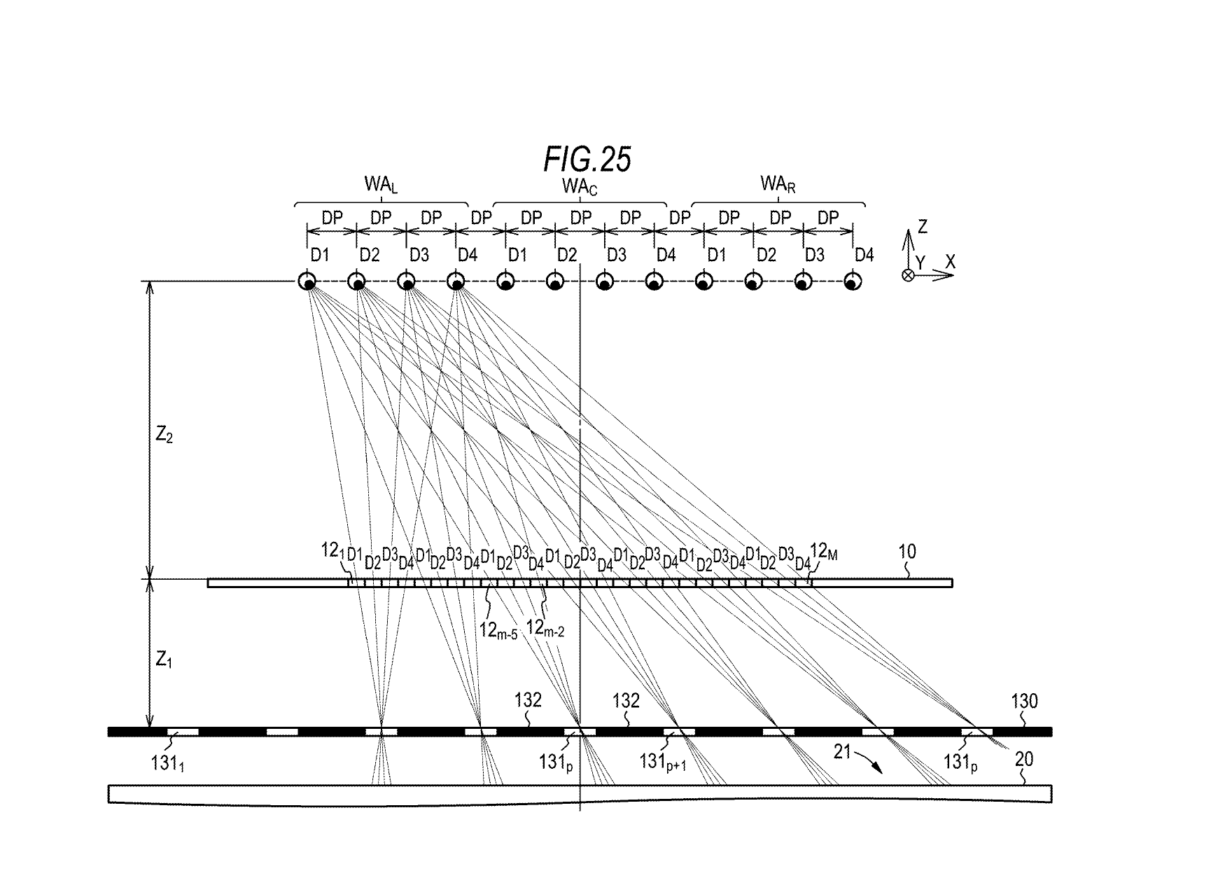

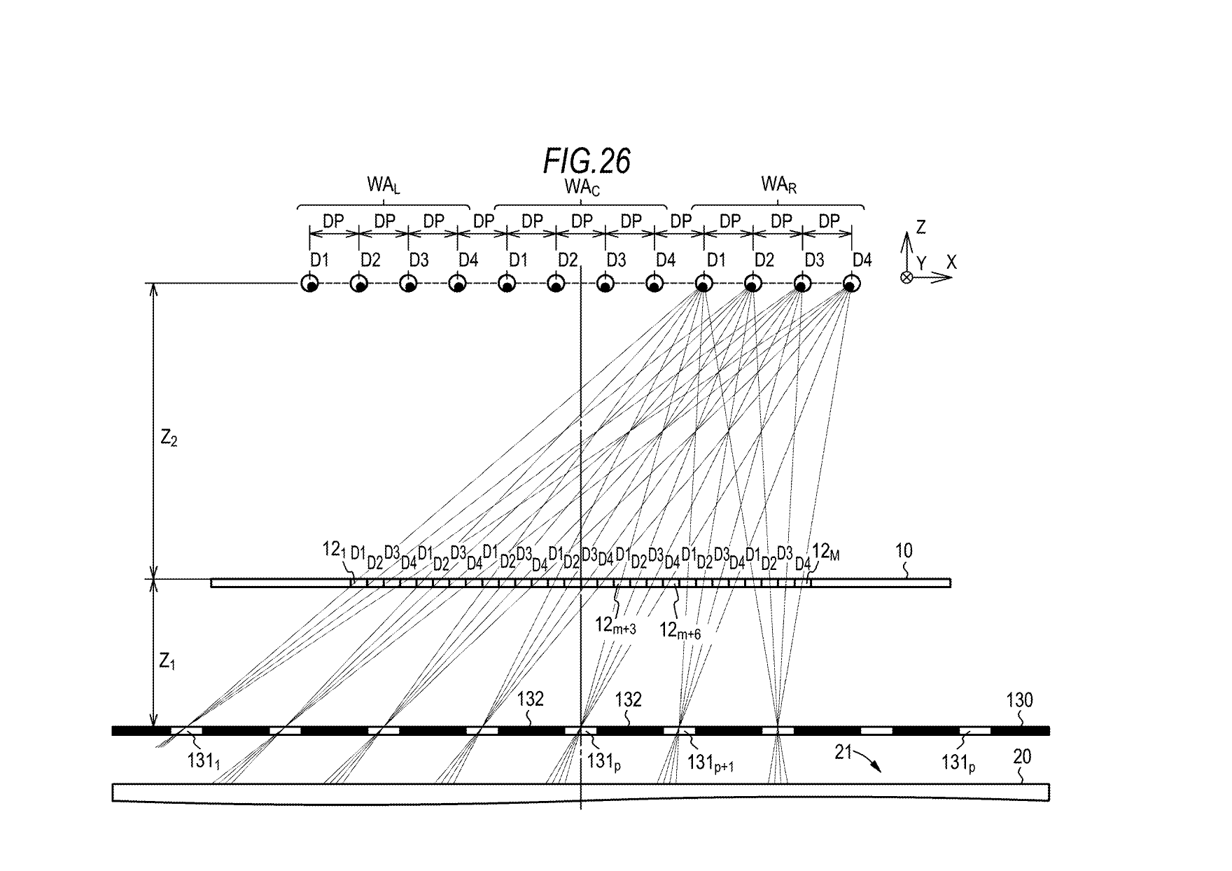

FIG. 24 is a schematic diagram illustrating an image viewed at the viewpoints D1, D2, D3 and D4 in the central viewing region WA_{C}. In addition, FIG. 25 is a schematic diagram illustrating an image viewed at the viewpoints D1, D2, D3 and D4 in the left viewing region WA_{L}. Further, FIG. 26 is a schematic diagram illustrating an image viewed at the viewpoints D1, D2, D3 and D4 in the right viewing region WA_{R}.

As illustrated in FIGS. 24, 25 and 26, an image formed by the pixels 12 such as the pixels 12₁, 12₅, 12₉, . . . is viewed at the viewpoint D1, and an image constituted by the pixels 12 such as the pixels 12₂, 12₆, 12₁₀, . . . is viewed at the viewpoint D2. In addition, an image formed by the pixels 12 such as the pixels 12₃, 12₇, 12₁₁, . . . is viewed at the viewpoint D3, and an image formed by the pixels 12 such as the pixels 12₄, 12₈, 12₁₂, . . . is viewed at the viewpoint D4. Therefore, an image for the first viewpoint is displayed using the pixels 12 such as the pixels 12₁, 12₅, 12₉, . . . , an image for the second viewpoint is displayed using the pixels 12 such as the pixels 12₂, 12₆, 12₁₈, . . . , an image for the third viewpoint is displayed using the pixels 12 such as the pixels 12₃, 12₇, 12₁₁, . . . , and an image for the fourth viewpoint is displayed using the pixels 12 such as the pixels 12₄, 12₈, 12₁₂, . . . . Thereby, an image viewer can recognize the images as stereoscopic images.

Although the number of viewpoints is “four” in the above description, the number of viewpoints may be appropriately selected according to the specification of the display apparatus. For example, there may be a configuration where the number of viewpoints is “two”, or the number of viewpoints is “six”. In this case, a configuration of the parallax barrier 130 or the like may be appropriately changed. This is also the same for the second and third embodiments described later.

Further, in the display apparatus according to the first embodiment, when α is any coefficient (any rational or irrational coefficient), for example, any coefficient equal to or more than 1, W₁ is changed to two values of W₁=α·ND and W₁=2α·ND. Here, in the display apparatus according to the first embodiment, specifically, 0.95≦α≦1.05 is satisfied, and, more specifically, α=1.0. Further, in a case where great importance is placed on image quality in the display apparatus, and great importance is not placed on luminance of an image, a form of W₁=α·ND may be employed, and, conversely, in a case where great importance is placed on luminance of an image in the display apparatus, and great importance is not placed on image quality, a form of W₁=2α·ND may be employed.

Here, since, in the first embodiment, the back barrier type is employed, and 0.95×ND≦W₁≦1.05×ND and 1.9×W₁≦2.1×ND are satisfied, not only moiré caused by a shape but also moiré caused by a diffraction phenomenon can be suppressed from occurring.

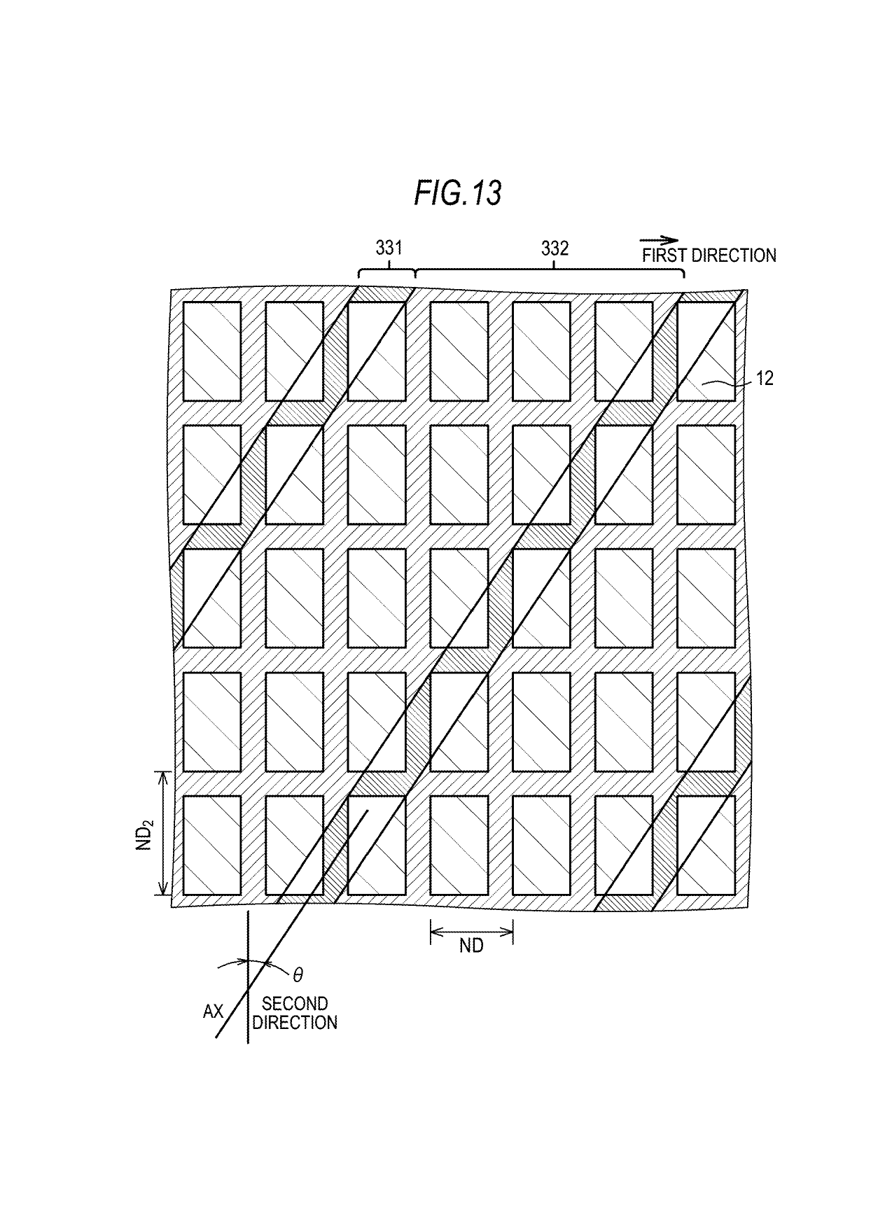

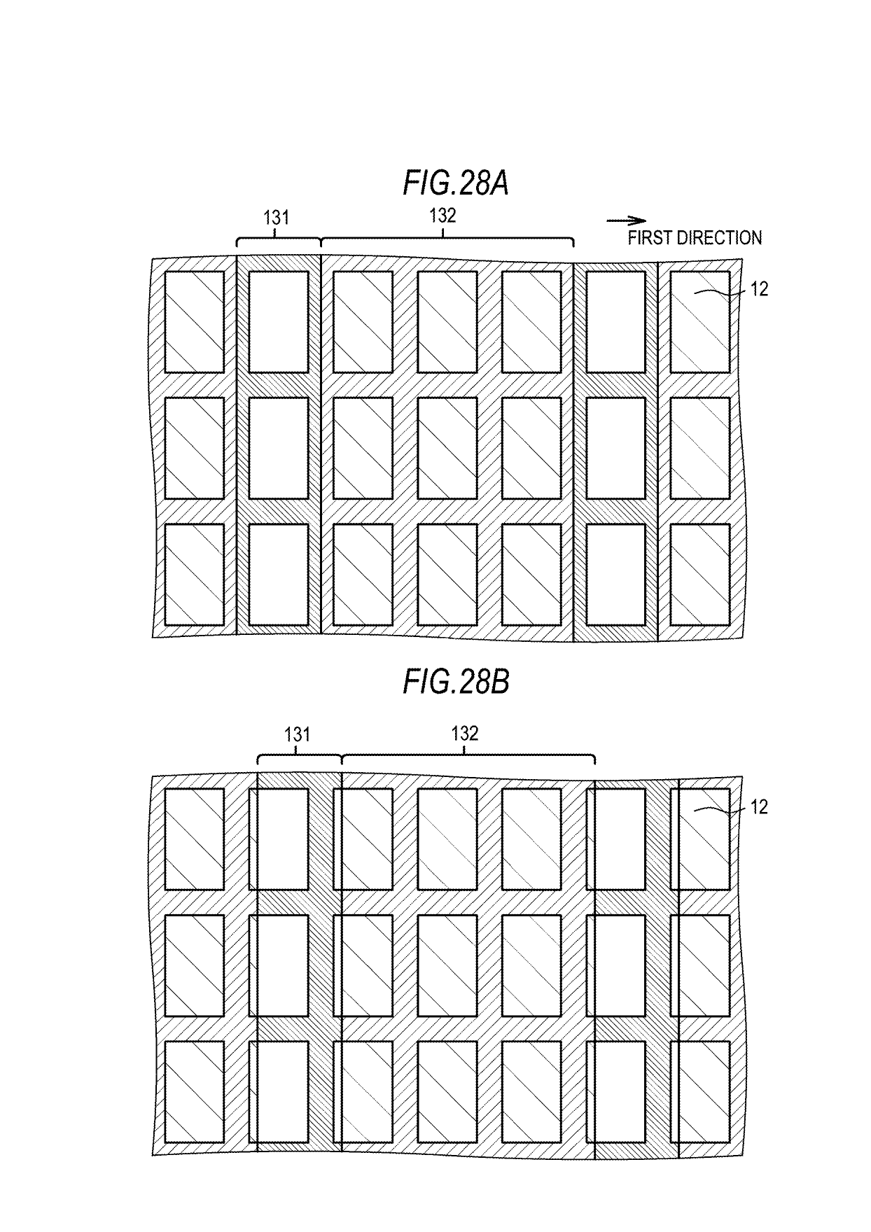

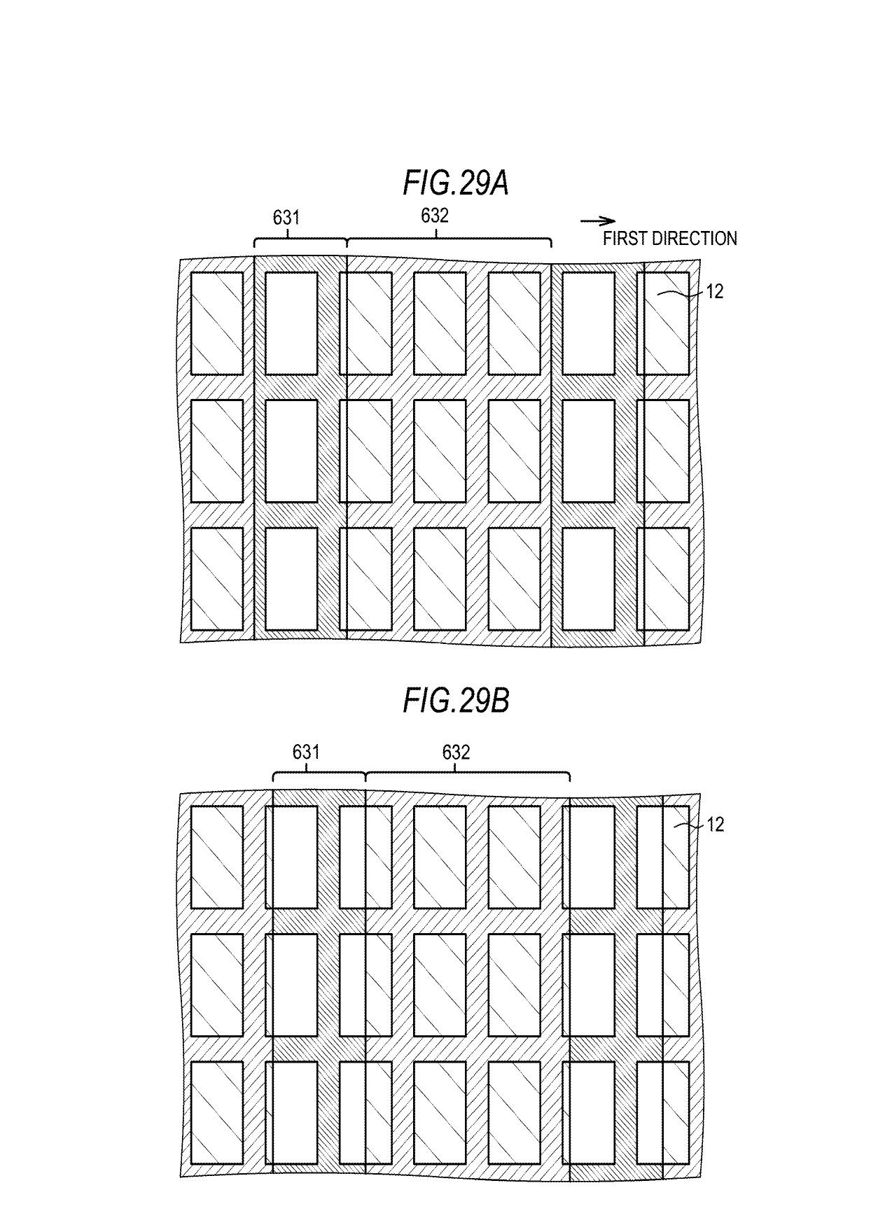

The cause of moiré caused by a shape occurring will be described with reference to FIGS. 28A and 28B and 29A and 29B which are schematic diagrams illustrating a disposition relationship between the transmissive display panel and the parallax barrier. In addition, in these figures, for convenience, the transmissive display panel and the parallax barrier are illustrated so as to overlap each other. Further, a region in which the light transmission sections 131 and 631 of the parallax barrier are projected onto the transmissive display panel is given hatching with the small width from the upper left to the lower right, and a region in which the light blocking sections 132 and 632 of the parallax barrier are projected onto the transmissive display panel is given hatching with the intermediate width from the upper right to the lower left. In addition, a portion overlapping the light blocking sections 132 and 632 is given the hatching with the large width from the upper left to the lower right. This is also the same for FIG. 13 described later. Each pixel is surrounded by the black matrix.

Here, in a case where the width of the light transmission section 131 of the parallax barrier in the first direction is the same as the arrangement pitch ND of the subpixels in the first direction (refer to FIG. 28A), even if the viewpoint of an image viewer which views an image is moved slightly in the first direction (refer to FIG. 28B), the area of a pixel portion which is not covered by the light blocking sections 132 does not vary. Therefore, even if the viewpoint of the image viewer which views an image is slightly moved in the first direction, the brightness of a screen does not vary. Accordingly, moiré does not occur.

On the other hand, in a case where the width of the light transmission section 631 of the parallax barrier in the first direction is not the same as the arrangement pitch ND of the subpixels in the first direction (refer to FIG. 29A), if the viewpoint of an image viewer which views an image is slightly moved in the first direction (refer to FIG. 29B), the area of a pixel portion which is not covered by the light blocking sections 632 varies. Therefore, if the viewpoint of the image viewer which views an image is slightly moved in the first direction, the brightness of a screen varies. Accordingly, moiré occurs.

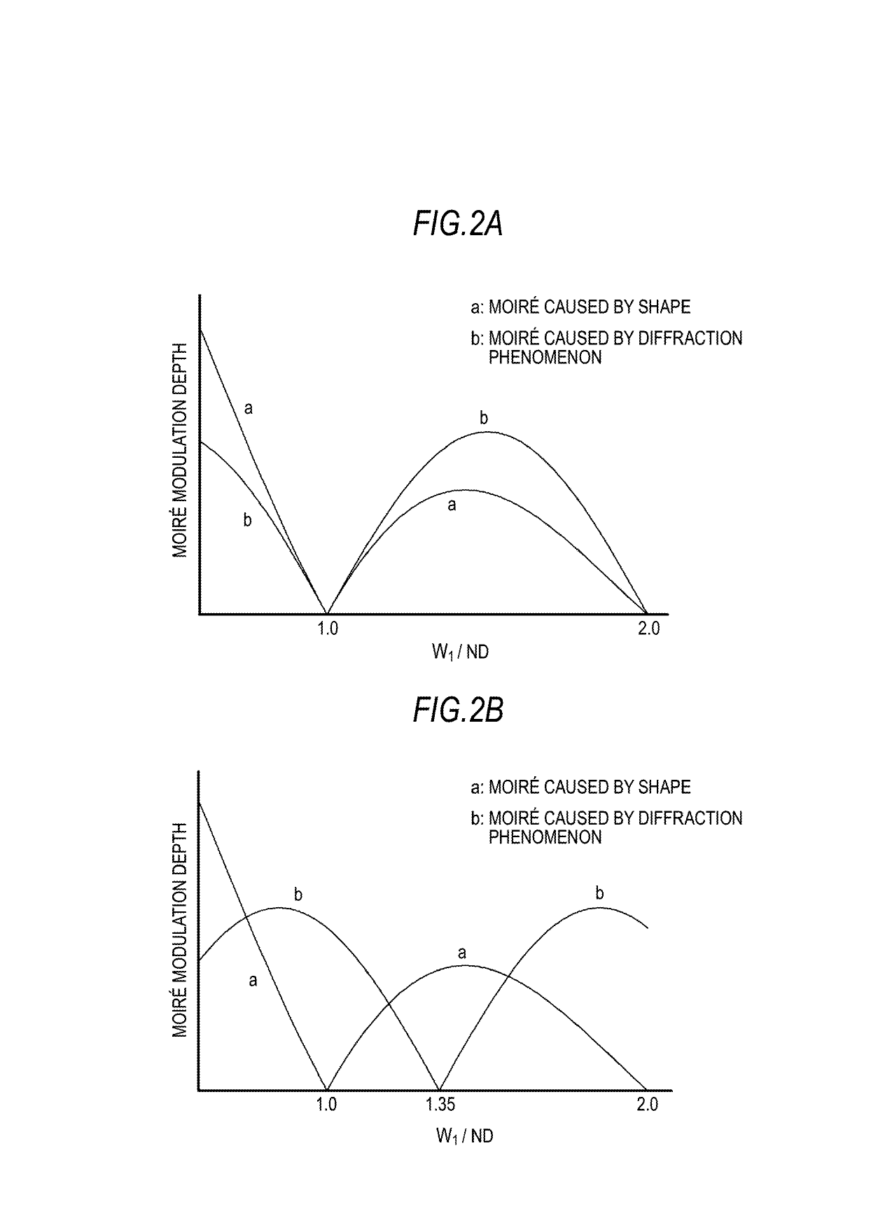

FIG. 2A illustrates a simulation result of the moiré modulation depth in the back barrier type display apparatus. In addition, FIG. 2B illustrates a simulation result of the moiré modulation depth in the front barrier type display apparatus. Further, in FIGS. 2A and 2B, the transverse axis expresses values of the width W₁ of the light transmission section in the first direction when the arrangement pitch ND of the pixels in the first direction is “1”. In FIGS. 2A and 2B, “a” indicates the moiré modulation depth due to moiré caused by a shape, and “b” indicates the moiré modulation depth due to moiré caused by a diffraction phenomenon. In addition, the longitudinal direction expresses the moiré modulation depth. Here, the moiré modulation depth may be indicated by a luminance variation [that is, (luminance maximum value−luminance minimum value)/(luminance maximum value+luminance minimum value)] due to moiré in a display screen of the display apparatus.

In the simulation of the moiré modulation depth, on the basis of illumination calculation of a partial coherence theory considering spatial coherence, diffraction calculation including a shape of the pixel in the transmissive display panel and a shape of the light transmission section in the parallax barrier is performed.

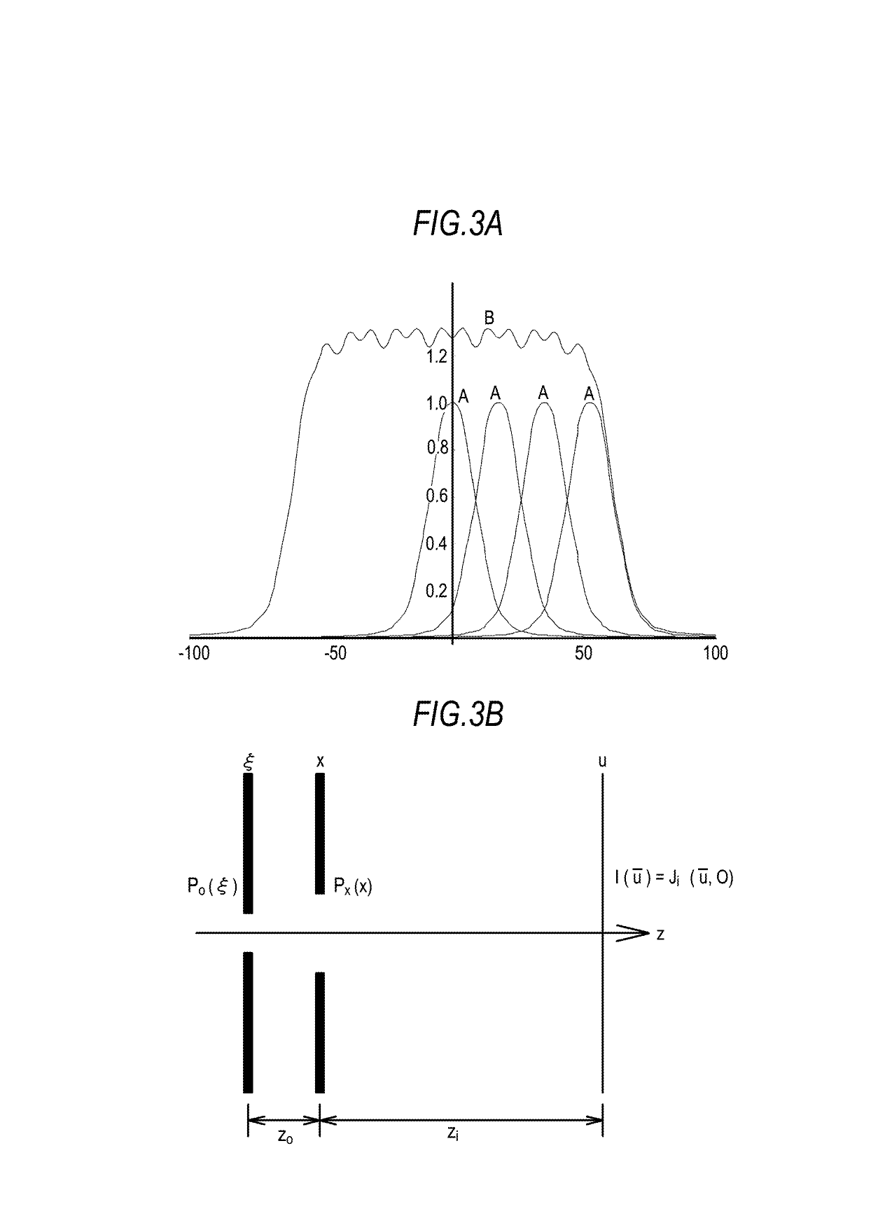

A direction vertical to the display region 11 of the transmissive display panel 10 is set as an optical propagation axis z, and how diffraction varies along the optical propagation axis z is estimated. In a calculation model, restriction to one axis direction is given depending on separation of variables. As illustrated in the conceptual diagram of FIG. 3B, a rectangular opening P₀(ξ) and a rectangular opening Pₓ(x) are placed on a ξ axis and an x axis which are spaced apart from each other by the gap z₀ (=Z₁). In a case of the back barrier type, P₀(ξ) corresponds to the light transmission section of the parallax barrier, and Pₓ(x) corresponds to the pixel of the transmissive display panel. On the other hand, in a case of the front barrier type, P₀(ξ) corresponds to the pixel of the transmissive display panel, and Pₓ(x) corresponds to the light transmission section of the parallax barrier. In addition, a u axis as an image viewing position (projection screen plane) is placed at a position of a distance zᵢ from the x axis. A purpose of the calculation is to obtain an optical profile on the u axis. Since the purpose is to obtain an optical profile at the image viewing position, a plane vertical to the z axis of the image viewing position is referred to as a projection screen plane for convenience.

Assuming an equivalent light source where alight source having spectral distribution of the central wavelength λ (in the following Expression (A), indicated by “λ bar” where a bar “−” is applied on the top of the symbol “λ”) is distributed at the opening P₀(ξ) on the ξ axis, spatial coherence of the light source is set to μ(Δξ). According to the calculation based on the partial coherence theory, the intensity I(u) on the screen may be expressed by the following Expression (A) by using the mutual intensity Jᵢ(u,0) on the screen. In addition, in the following Expression (A), the symbol u is indicated by “u bar” where a bar “−” is applied on the top of the symbol “u”.

$$I ( \overline{u} ) = {J}_{i} ( \overline{u} , 0 ) = \frac{{I}_{o}}{{( \overline{λ} {z}_{o} )}^{2} {( \overline{λ} {z}_{i} )}^{2}} \times {\int }_{- ∞}^{∞} \{ {\int }_{- ∞}^{∞} {P}_{x} ( \overline{x} - Δ x / 2 ) {P}_{x}^{*} ( \overline{x} + Δ x / 2 ) \times \{ {\int }_{- ∞}^{∞} μ ( Δξ ) ( {\int }_{- ∞}^{∞} {P}_{o} ( \overline{ξ} - Δξ / 2 ) {P}_{o}^{*} ( \overline{ξ} + Δξ / 2 ) exp [ j \frac{2 π}{\overline{λ} {z}_{o}} ( \overline{ξ} Δ x - \overline{ξ} Δξ ) ] d \overline{ξ} ) \times exp [ j \frac{2 π}{\overline{λ} {z}_{o}} \overline{x} Δξ ] d Δξ \} \times exp [ - j \frac{2 π}{\overline{λ}} ( \frac{1}{{z}_{o}} + \frac{1}{{z}_{i}} ) \overline{x} Δ x ] d \overline{x} \} \times exp [ j \frac{2 π}{\overline{λ}} \frac{\overline{u} Δ x}{{z}_{i}} ] d Δ x \qquad ( A )$$

Here, I° indicates a constant indicating the light intensity, the respective variables, “ξ bar” where a bar “−” is applied on the top of the symbol ξ, “x bar” where a bar “−” is applied on the top of x, and “u bar” indicate respectively central positions of two variables ξ₁, ξ₂, x₁, x₂, u₁ and u₂ when the mutual intensity based on the partial coherence theory is defined at each of the ξ axis plane, the x axis plane, and the u axis plane, and, Δξ and Δx indicate difference values between the two variables. In addition, it is possible to calculate distribution of light from a specific pixel and a region of the parallax barrier on the basis of Expression (A), and to thereby accurately estimate the light intensity of pixels viewed by an image viewer at a specific position.

Here, by using the optical profile calculation expression (A) in the projection screen plane by light from each pixel, it is possible to obtain radiation luminance distribution in a case where all the pixels are lighted (totally white display). P_{(0,n)}(ξ) is regulated for each pixel, and an optical profile Iₙ(u) (in the following Expression (B), indicated by “u bar” where a bar “−” is applied on the top of the symbol “u”) formed by the pixel is calculated. Totally white lighting is obtained by summing illumination by all the pixels and thus can be obtained from the following Expression (B).

$${I}_{total} ( \overline{u} ) = {\sum }_{n} {l}_{n} ( \overline{u} ) \qquad ( B )$$

An example where practical calculation was performed based on Expression (B) is illustrated in FIG. 3A. The luminance profile Iₙ(u) (FIG. 3A illustrates the luminance profile “A” based on each of four pixels) based on each of seven pixels was calculated, and the total luminance Iₜₒₜₐₗ(U) indicated by “B” in FIG. 3A. When attention is paid to the luminance profile (optical profile) of the total luminance, luminance unevenness occurs at a period higher than an overlapping period of the respective pixels, which shows that a radiation angle distribution characteristic from a certain point (specific slit) of the display region 11 of the transmissive display panel 10 has fine angle dependency. In addition, the transverse axis of FIG. 3A expresses a distance (unit: mm) on the u axis, and the longitudinal axis expresses a luminance relative value when I° is “1.0”. This luminance unevenness (refer to the notched portions of the top of the figure (for example, “B” in FIG. 3A) similar to a trapezoid in the graphs of FIGS. 3A, 4 and 5) corresponds to the moiré modulation depth.

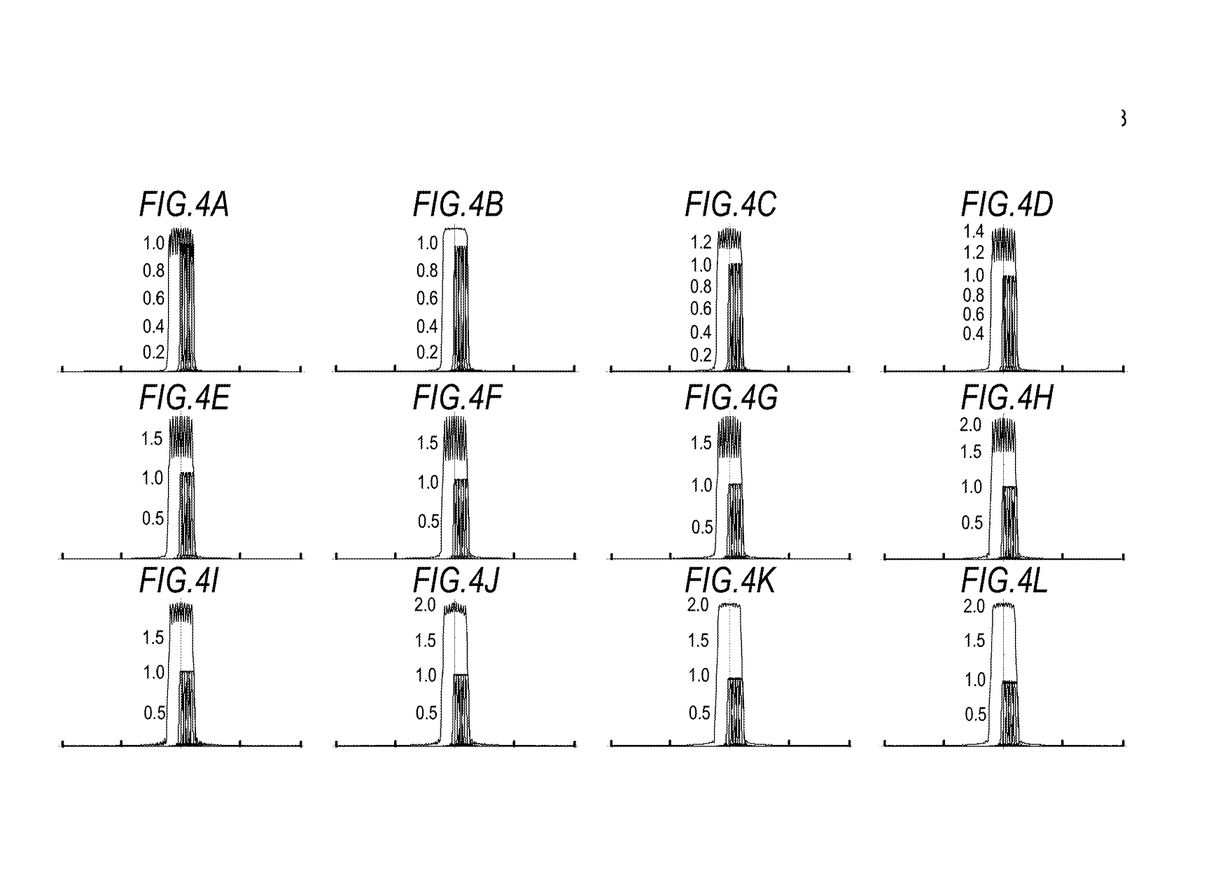

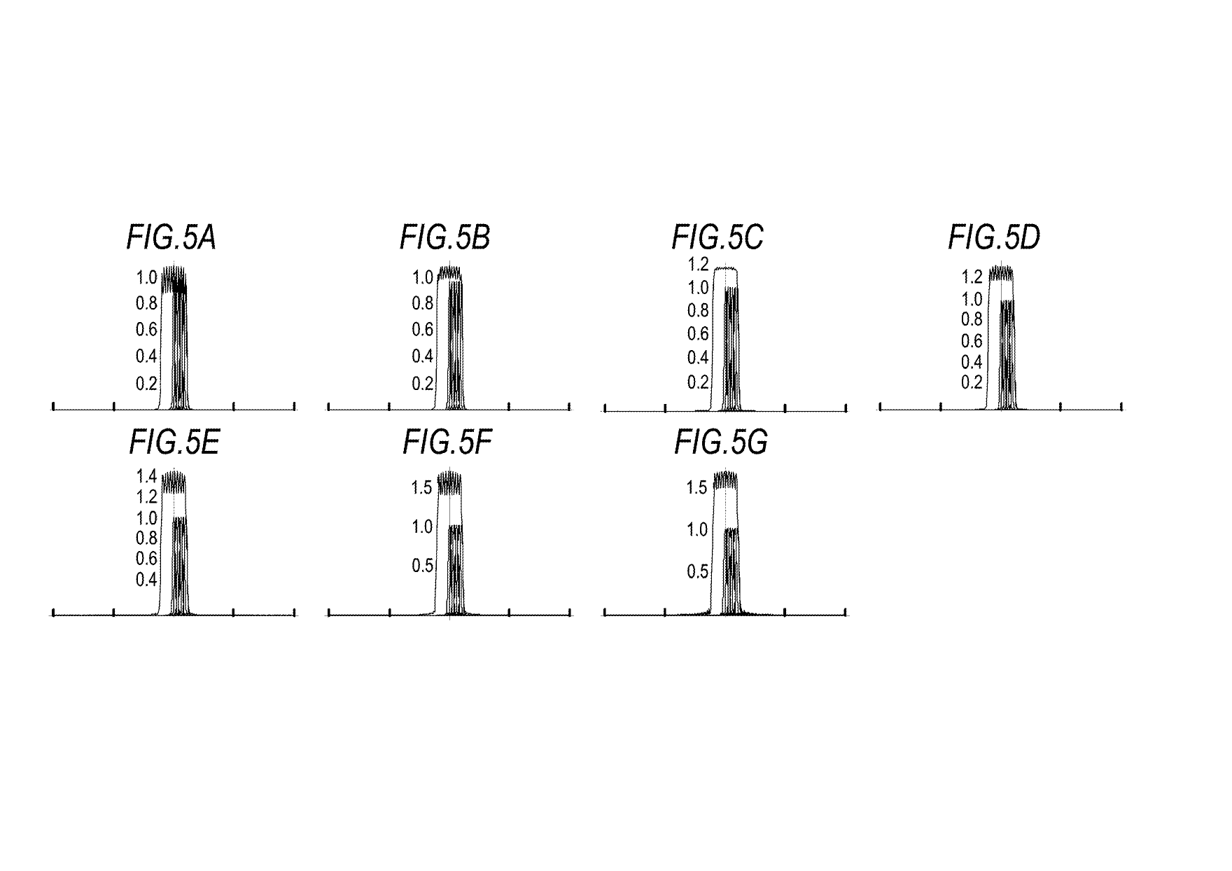

FIGS. 4A to 5G illustrate a calculation example of the moiré modulation consideration diffraction. In addition, FIGS. 4A to 4L illustrate a calculation result of moiré modulation in the back barrier type display apparatus, and FIGS. 5A to 5G illustrate a calculation result of moiré modulation in the front barrier type display apparatus. FIG. 4A indicates a case of W₁/ND=0.9, FIG. 4B indicates a case of W₁/ND=1.0, FIG. 4C indicates a case of W₁/ND=1.1, FIG. 4D indicates a case of W₁/ND=1.2, FIG. 4E indicates a case of W₁/ND=1.3, FIG. 4F indicates a case of W₁/ND=1.4, FIG. 4G indicates a case of W₁/ND=1.5, FIG. 4H indicates a case of W₁/ND=1.6, FIG. 4I indicates a case of W₁/ND=1.7, FIG. 4J indicates a case of WiND=1.8, FIG. 4K indicates a case of W₁/ND=2.0, and FIG. 4L indicates a case of W₁/ND=2.1. In addition, FIG. 5A indicates a case of W₁/ND=1.1, FIG. 5B indicates a case of W₁/ND=1.2, FIG. 5C indicates a case of W₁/ND=1.3, FIG. 5D indicates a case of WiND=1.4, FIG. 5E indicates a case of W₁/ND=1.5, FIG. 5F indicates a case of W₁/ND=1.6, and FIG. 5G indicates a case of W₁/ND=1.7. In FIGS. 4A to 5G, the transverse axis expresses a distance on the u axis, and one scale indicates one meter. In addition, the longitudinal axis expresses a relative luminance when I₀ is “1.0”. Further, the following parameters were used for the calculation.

### Back Barrier Type Display Apparatus According to the First Embodiment Illustrated in FIGS. 4A to 4L

Width of rectangular opening P₀(ξ): 176 μm

Pitch of rectangular opening P₀(ξ): 176 μm

Spatial coherence length Δμ: 0.03 μm

Width of Pₓ(x): 130 μm

Central wavelength λ₀: 500 nm

Gap z₀: 17.8 mm

zᵢ: 4 m

### Front Barrier Type Display Apparatus in the Related Art Illustrated in FIGS. 5A to 5G

Width of rectangular opening P₀(ξ): 130 μm

Pitch of rectangular opening P₀(ξ): 176 μm

Spatial coherence length Δμ: 0.03 μm

Width of Pₓ(x): 176 μm

Central wavelength λ₀: 500 nm

Gap z₀: 17.8 mm

zᵢ: 4 m

In addition, Δμ is called a spatial coherence length, and indicates a distance where coherence between two points in the lateral direction is maintained. As an example, a coherence function μ(Δξ) indicating coherence between two points may be expressed as μ(Δξ)=exp[−Δξ²/(2·Δμ²)]/(2π)^{1/2} by using a distance Δξ between the two points on a light source. This function has a property that the function becomes a certain constant value (1/(2π)^{1/2}) if Δξ is small (that is, if the distance between two points is very short), and the function rapidly decreases if Δξ is larger than Δμ, and is generally used as a function indicating spatial coherence.

From FIG. 2A, in the back barrier type display apparatus, the moiré modulation depth based on moiré caused by a shape and moiré caused by a diffraction phenomenon becomes the minimum if the value of W₁/ND increases and becomes “1”. In addition, the moiré modulation depth increases and then decreases if the value of W₁/ND exceeds “1”. Further, the moiré modulation depth becomes the minimum if the value of W₁/ND becomes “2”. On the other hand, in the front barrier type display apparatus, the moiré modulation depth based on moiré caused by a shape becomes the minimum if the value of W₁/ND increases and becomes “1”. In addition, the moiré modulation depth increases and then decreases if the value of W₁/ND exceeds “1”. Further, the moiré modulation depth becomes the minimum if the value of W₁/ND becomes “2”. However, the moiré modulation depth based on moiré caused by a diffraction phenomenon becomes the minimum if the value of W₁/ND increases and is put between “1” and “2”. In addition, the moiré modulation depth increases if the value of W₁/ND exceeds it, but has a large value even if the value of W₁/ND becomes “2”. In other words, in the back barrier type display apparatus, when the value of W₁/ND is “1” or “2”, it is possible to suppress both the moiré caused by a shape and the moiré caused by a diffraction phenomenon from occurring. On the other hand, in the front barrier type display apparatus, it was proved that, when the value of W₁/ND is “1” or “2”, occurrence of the moiré caused by a shape can be suppressed, but it is difficult to suppress the moiré caused by a diffraction phenomenon from occurring.

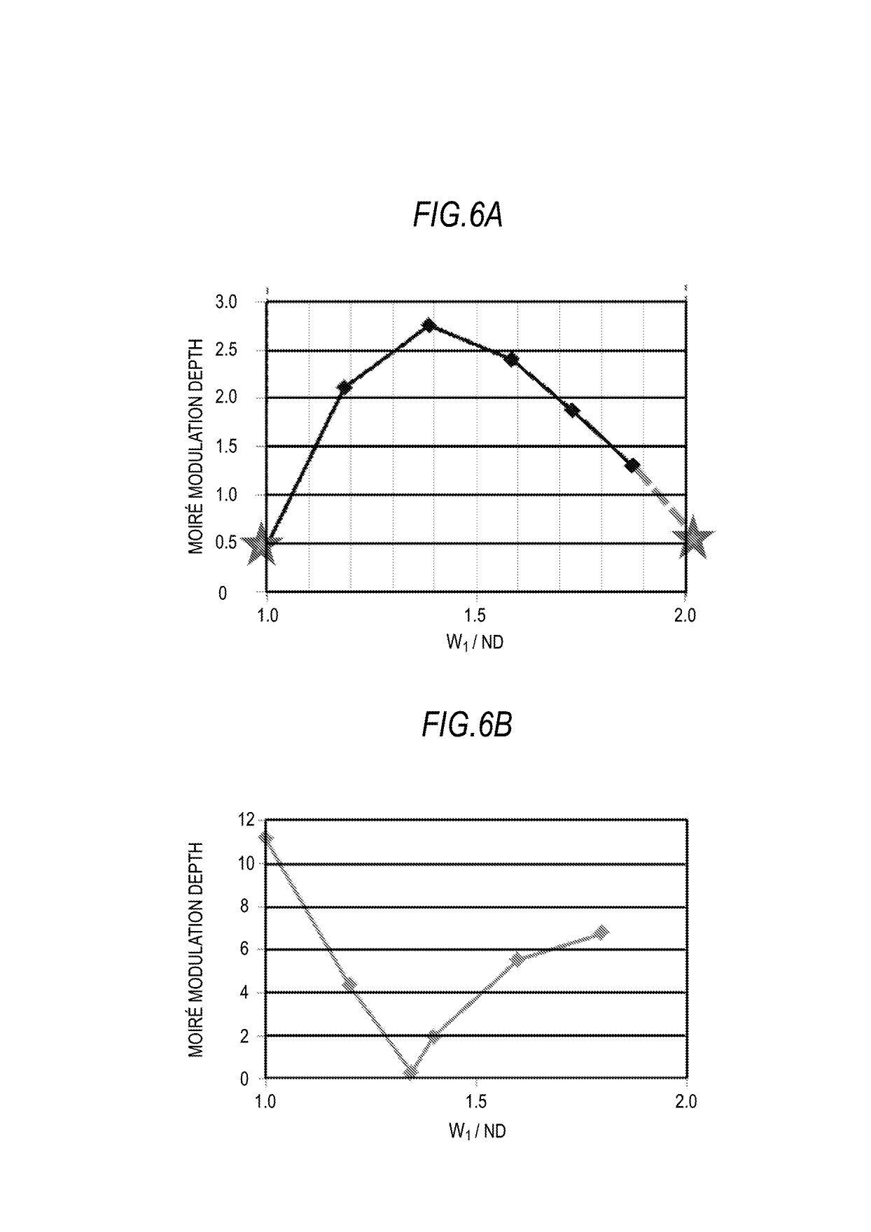

FIG. 6A illustrates a result that the parallax barriers 130 of which W₁ is different were experimentally produced and the moiré modulation depth was practically measured in totally white display in the back barrier type display apparatus, and FIG. 6B illustrates a result in which the moiré modulation depth was practically measured in a totally white display in the front barrier type display apparatus. The results of measuring the moiré modulation depth of FIGS. 6A and 6B substantially conform to the simulation results illustrated in FIGS. 2A and 2B, particularly, the simulation result of the moiré modulation depth based on moiré caused by a diffraction phenomenon. That is to say, it is expected that moiré caused by a diffraction phenomenon may occur seriously in a practical display apparatus. In addition, it can be seen that occurrence of moiré can be sufficiently suppressed by optimizing the value of W₁/ND even in the front barrier type display apparatus.

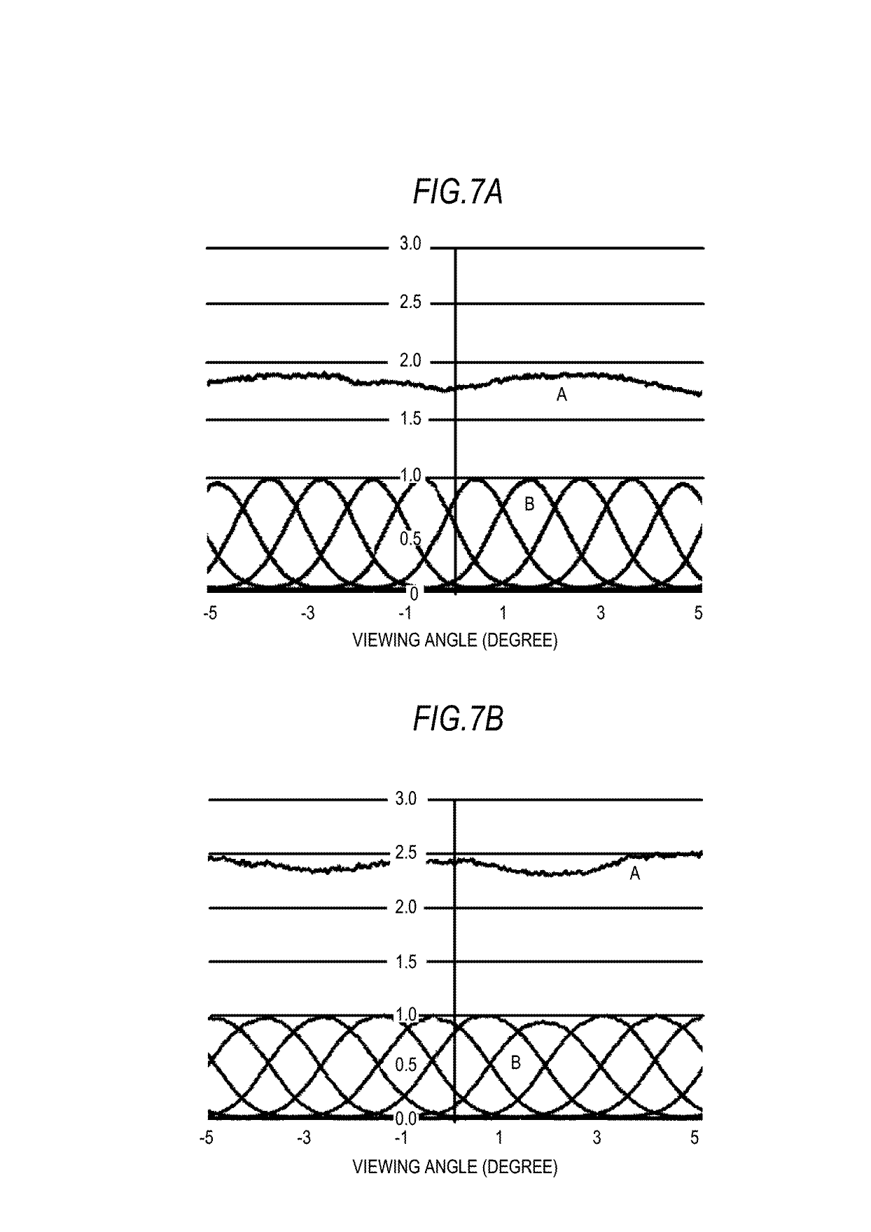

In the back barrier type display apparatus, when W₁=α·ND and W₁=2α·GND, how crosstalk varies was practically measured if a viewing angle where the display apparatus is viewed varies from 0 degrees. In addition, in the test, eight luminance profiles, and luminance profiles based on crosstalk were obtained. FIGS. 7A and 7B respectively illustrate results when W₁=α·ND and W₁=2α·ND. Further, in FIGS. 7A and 7B, the eight luminance profiles are indicated by “B”, and a luminance profile of crosstalk where the eight luminance profiles are viewed so as to overlap each other is indicated by “A”. In FIGS. 7A and 7B, the transverse axis expresses a viewing angle (unit: degree), the longitudinal axis expresses a relative luminance value, and an average value of the maximum luminance values of the eight luminance profiles B is “1”. From FIGS. 7A and 7B, it can be seen that a luminance difference between the luminance profiles B and the luminance profile A is larger and crosstalk is greater in a case of W₁=2α·ND than in a case of W₁=α·ND.

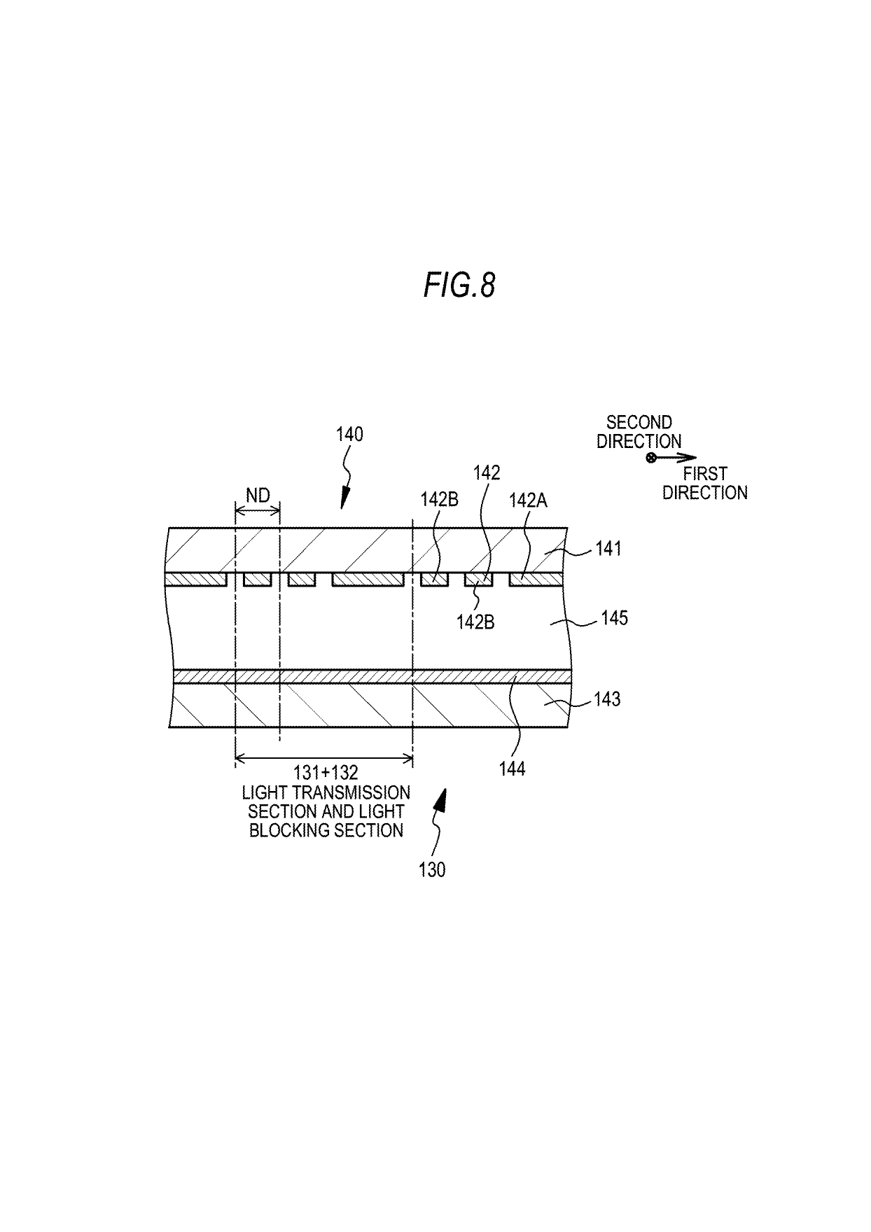

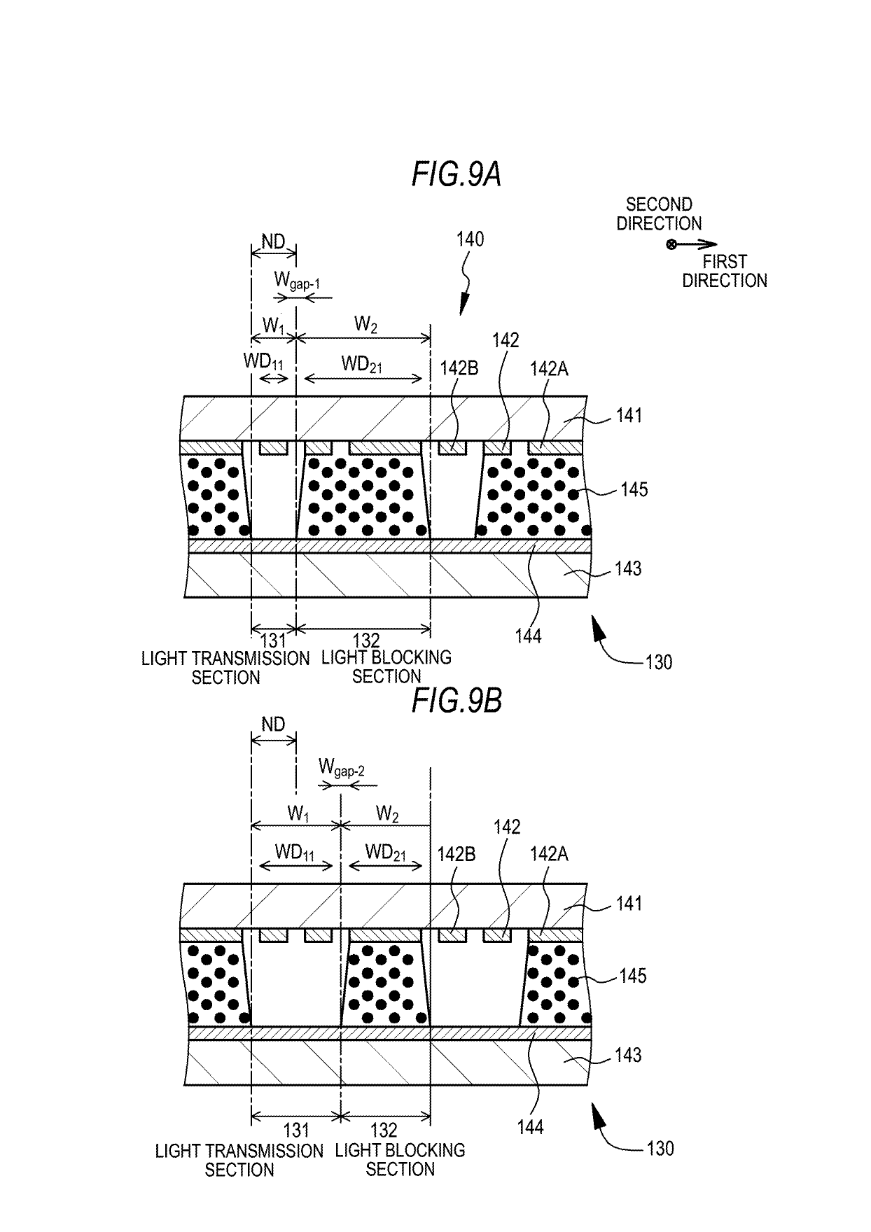

In the first embodiment, the parallax barrier 130 includes a liquid crystal display device 140. That is to say, as illustrated in the schematic partial cross-sectional views of FIG. 8 and FIGS. 9A and 9B, the parallax barrier 130 of the display apparatus according to the first embodiment at least includes a first substrate 141, a first electrode 142 formed and patterned on the first substrate 141, a second substrate 143 disposed so as to be opposite to the first substrate 141, a second electrode 144 formed on the second substrate 143 so as to be opposite to the first electrode 142, and a liquid crystal layer 145 interposed between the first substrate 141 and the second substrate 143. The disposition state of the light transmission sections 131 of the parallax barrier 130 and the pixels (subpixels) 12 of the transmissive display panel 10 is the same as illustrated in FIGS. 28A and 28B.

The patterned first electrode 142 made of a transparent electrode material extends in the second direction. On the other hand, the second electrode 144 made of a transparent electrode material is a so-called plain electrode which is not patterned. A configuration and a structure of the liquid crystal display device 140 forming the parallax barrier 130 are equal or similar to the configuration and structure of the liquid crystal display panel forming the transmissive display panel 10 except for the configuration and structure of the pixels and the subpixels. In addition, a switching element, a color filter, and a black matrix are not necessary.

In addition, in the liquid crystal display device 140 forming the parallax barrier 130, a set of the light transmission section 131 and the light blocking section 132 includes a first electrode 142A forming a single light blocking section 132 and two first electrodes 142B forming the light transmission section 131. Further, in a case where the width W₁ of the light transmission section 131 in the first direction is substantially the same as the arrangement pitch ND of the pixels in the first direction (for convenience, referred to as a “first case”), the light transmission section 131 includes a single first electrode 142B, and the light blocking section 132 includes a single first electrode 142A and the one remaining first electrode 142B. On the other hand, in a case where the width W₁ of the light transmission section 131 in the first direction is substantially twice the arrangement pitch ND of the pixels in the first direction (for convenience, referred to as a “second case”), the light transmission section 131 includes two first electrodes 142B, and the light blocking section 132 includes a single first electrode 142A. Here, the width WD₂₁ in the first direction of the first electrode 142A forming the light blocking section 132 is smaller than the width W₂ of the light blocking section 132 in the first direction, and, the width WD₁₁ in the first direction of the first electrode 142B forming the light transmission section 131 is smaller than the width W₁ of the light transmission section in the first direction. Specifically, in the first case, W₂−WD₂₁=10 μm, and W₁−WD₁₁=10 μm (refer to FIG. 7A). In addition, in the second case as well, W₂−WD₂₁=10 μm, and W₁−WD₁₁=10 μm (refer to FIG. 9B). Further, the gap width W_{gap-1} between the first electrode 142B and the first electrode 142B, and the gap width W_{gap-2} between the first electrode 142A and the first electrode 142B are W_{gap-1}=10 μm, and W_{gap-2}=10 μm. The width W₁ of the light blocking section in the first direction is changed to either W₁=10.0×ND or W₁=2.0×ND depending on the application state of a voltage to the first electrode 142 and the second electrode 144 (refer to FIGS. 9A and 9B). The width W₁ of the light transmission section is changed, and thereby it is possible to increase the luminance of an image displayed on the transmissive display panel 10. The liquid crystal layer 145 of the liquid crystal display device 140 forming the parallax barrier 130 may be in a state (normally white) of transmitting light therethrough or in a state (normally black) of not transmitting light therethrough when a voltage is not applied to the first electrode 142 and the second electrode 144. In addition, in the state of the liquid crystal display device 140 illustrated in FIG. 8, a two-dimensional image can be displayed.

Specifically, as described above, if the pixel pitch ND of the transmissive display panel 10 is 0.100 mm, the distance Z₂ is 1500 mm, and the distance DP is 65.0 mm, the distance Z₁ is 2.31 mm, and the light transmission section pitch RD is 0.400 mm. Here, in the first case, W₁=0.100 mm, and W₂=0.300 mm, or, in the second case, W₁=0.200 mm, and W₂=0.200 mm. In addition, W₁₁=0.090 mm, and W₂₁=0.190 mm.

In addition, in the first embodiment, the haze value of the transmissive display panel 10 is 4%. Specifically, a film obtained by applying surface roughing treatment to a surface of a transparent film (not illustrated) such as a PET film or a TAC film, or a film in which particles having different refractive indices are sprayed may be bonded to the transmissive display panel 10. This form may be applied to a variety of embodiments described below.

In the display apparatus according to the first embodiment, stereoscopic images and two-dimensional images can be displayed, or different images can be displayed when the display apparatus is viewed from different angles. In addition, in the display apparatus according to the first embodiment, since the width of the light transmission section in the first direction is variable, in a case of making a request for high image quality of images displayed on the display apparatus, the width of the light transmission section may be small [W₁=α·ND], and, in a case of making a request for high luminance, the width of the light transmission section may be large [W₁=2α·ND]. Therefore, it is possible to appropriately handle and support both the case of making a request for high image quality of images displayed on the display apparatus and the case of making a request for high luminance thereof.

### 3. Second Embodiment

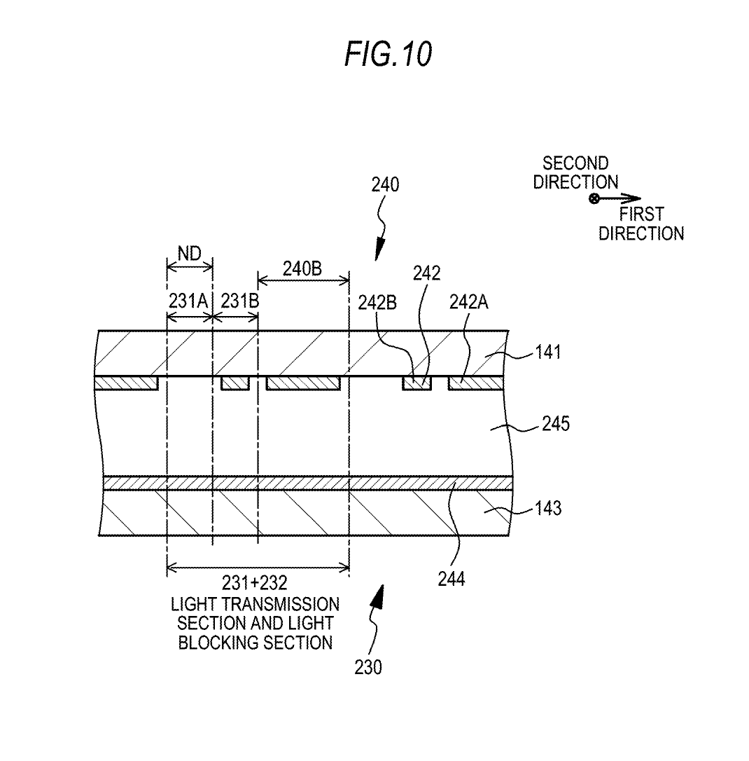

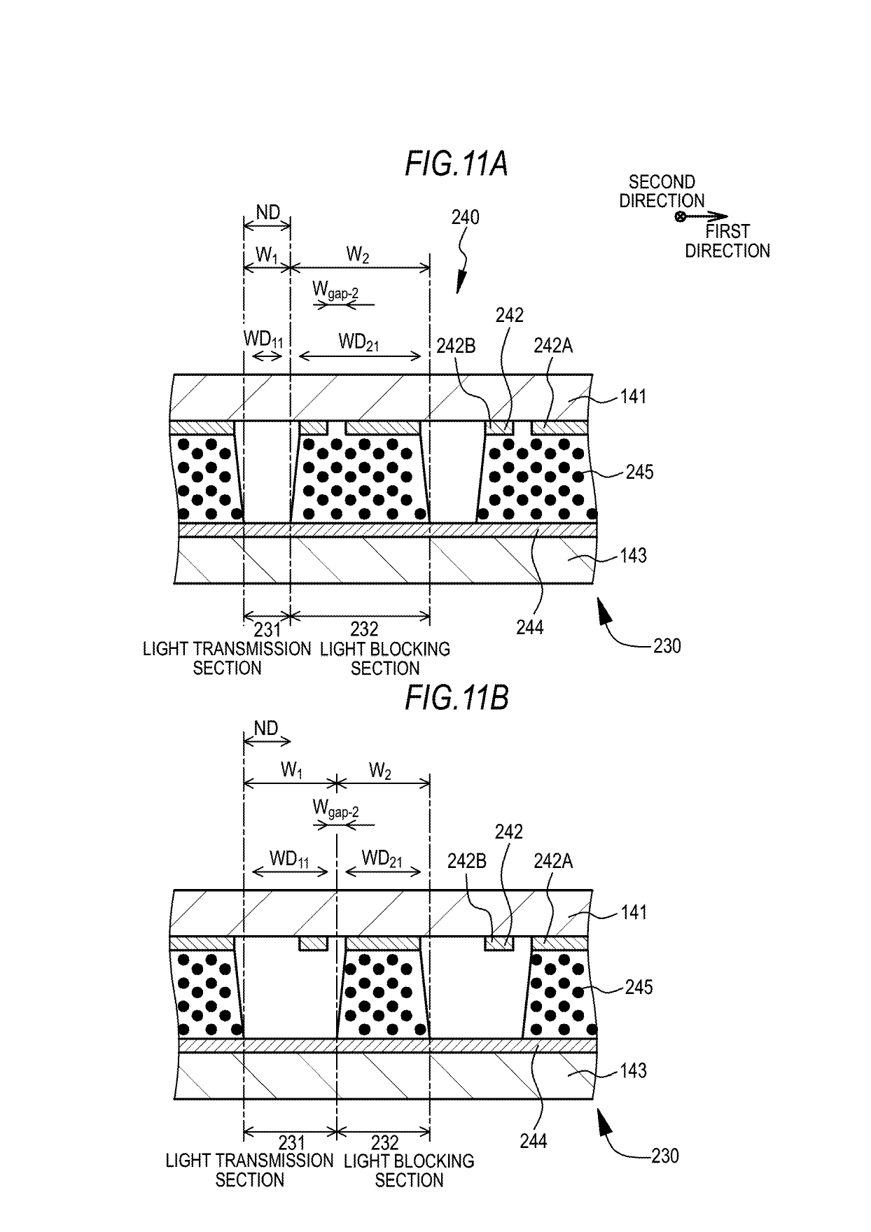

The second embodiment is a modification of the first embodiment. In the second embodiment, as illustrated in FIG. 10 and FIGS. 11A and 11B which are schematic partial cross-sectional views of a liquid crystal display device 240 forming a parallax barrier 230, a first electrode 242A is formed in a region 240B of the liquid crystal display device forming a light blocking section 232. In addition, a light transmission section 231 includes a region 231B in which the first electrode 242B is formed and a region 231A in which the first electrode is not formed, which are arranged in parallel in the first direction. Further, in a case where the width W₁ of the light transmission section 231 in the first direction is substantially the same as the arrangement pitch ND of the pixels in the first direction (a first case), the light transmission section 231 includes the region 231A in which the first electrode is not formed, and the light blocking section 232 includes the first electrode 242A and the first electrode 242B. On the other hand, in a case where the width W₁ of the light transmission section 231 in the first direction is substantially twice the arrangement pitch ND of the pixels in the first direction (a second case), the light transmission section 231 includes the region 231B in which the first electrode 242B is formed and the region 231A in which the first electrode is not formed, and the light blocking section 232 includes the first electrode 242A. Here, the width WD₁₁ in the first direction of the first electrode 242B forming the light transmission section 231 is smaller than the width W₁ of the light transmission section 231 in the first direction. Specifically, in the first case, W₁−WD₁₁=10 μm (refer to FIG. 11A). In addition, in the second case as well, W₁−WD₁₁=10 μm (refer to FIG. 11B). Further, the gap width W_{gap-2} between the first electrode 242B and the first electrode 242A is the same as in the first embodiment. The liquid crystal layer 245 of the liquid crystal display device 240 forming the parallax barrier 230 is in a state (normally white) of transmitting light therethrough when a voltage is not applied to the first electrode 242 and the second electrode 244. In addition, in the second embodiment as well, the width W₁ of the light blocking section 231 in the first direction is changed to either W₁=1.0×ND or W₁=2.0×ND depending on the application state of a voltage to the first electrode 242 and the second electrode 244 (refer to FIGS. 11A and 11B). The width W₁ of the light transmission section is changed, and thereby it is possible to increase the luminance of an image displayed on the transmissive display panel 10. In addition, in the state of the liquid crystal display device 240 illustrated in FIG. 10, a two-dimensional image can be displayed.

### 4. Third Embodiment

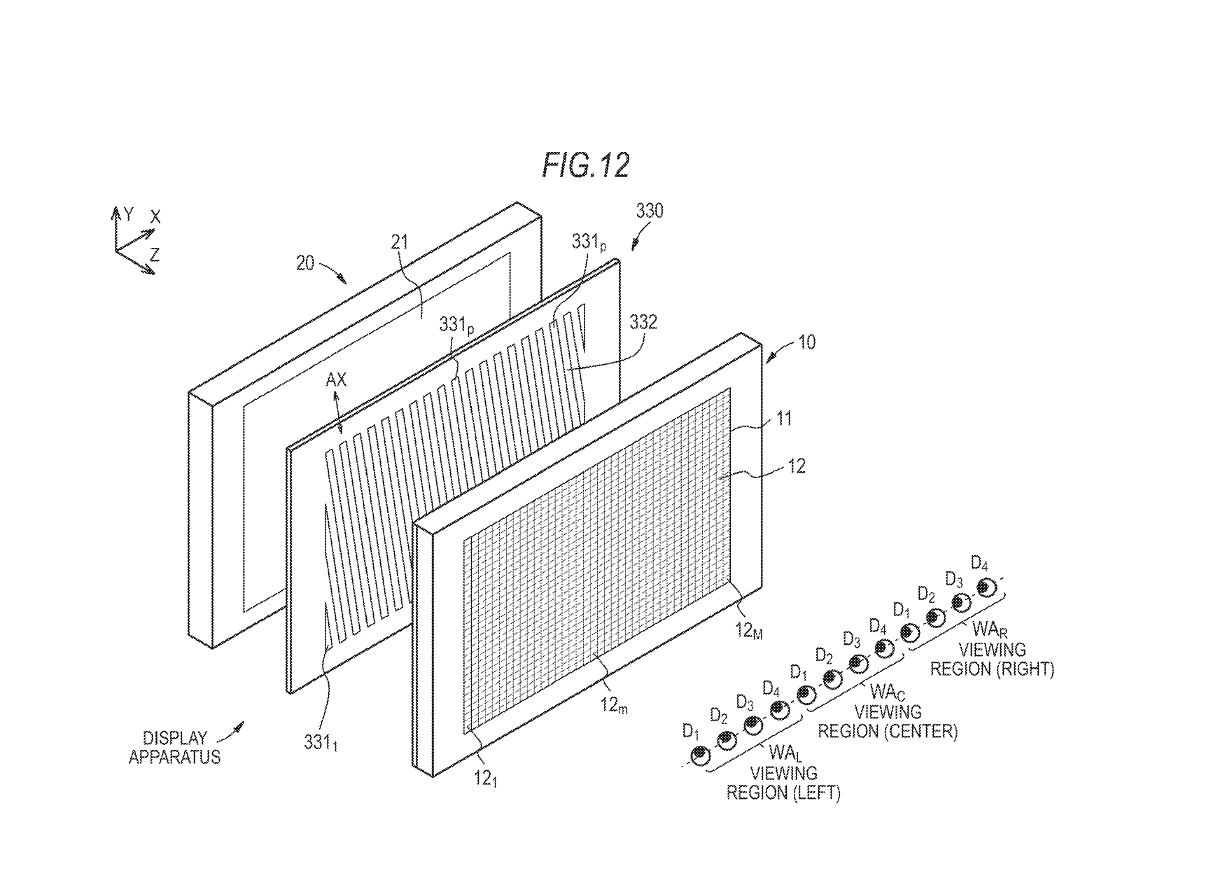

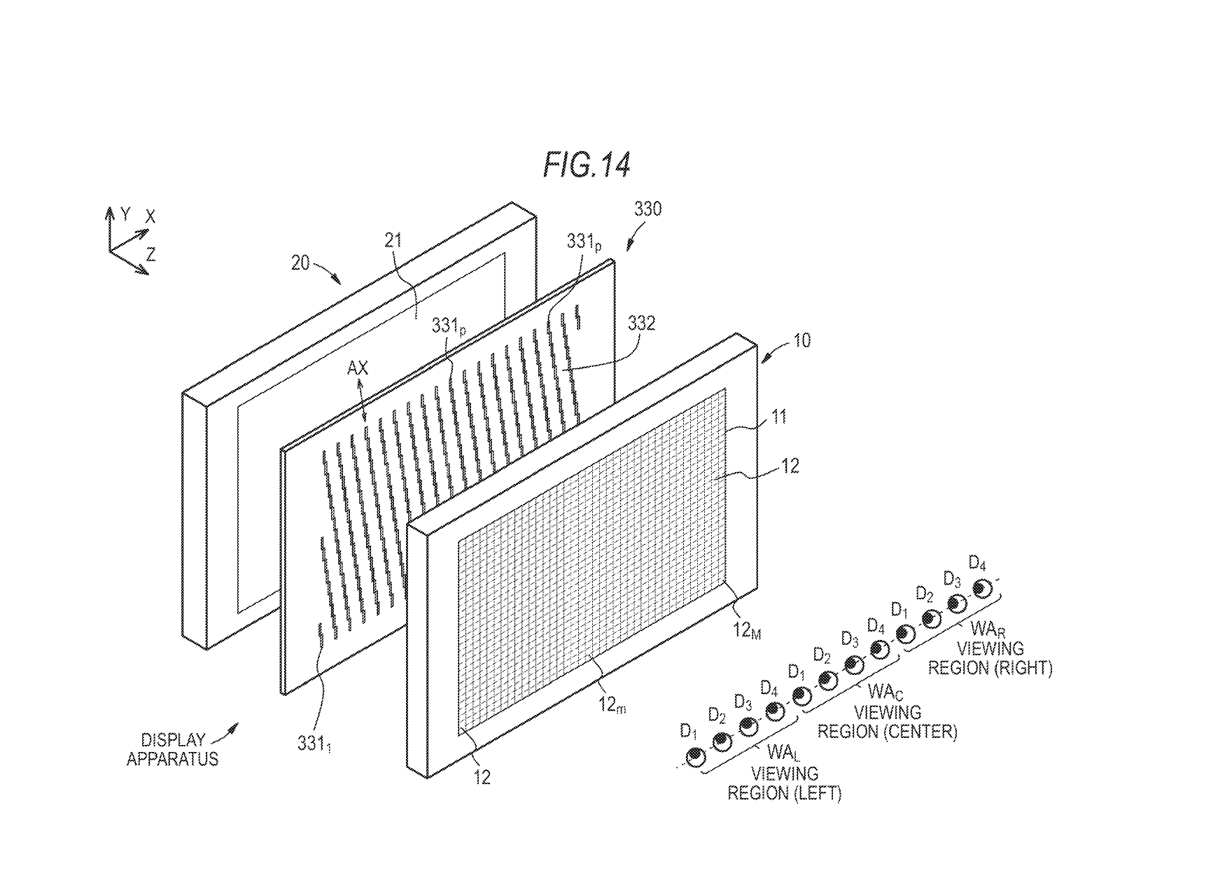

The third embodiment is a modification of the first and second embodiments. FIG. 12 is a schematic perspective view when a display apparatus according to the third embodiment is virtually separated. In addition, FIG. 13 is a schematic diagram illustrating a disposition relationship between a transmissive display panel 10 and a parallax barrier 330 of the display apparatus according to the third embodiment. Further, FIG. 14 is a schematic perspective view when a display apparatus according to a modified example of the third embodiment is virtually separated.

In the third embodiment, an angle θ formed by the axial line AX of a parallax barrier 330 and the second direction is an acute angle, and a light transmission section 331 and a light blocking section 332 of the parallax barrier 330 satisfy θ=tan⁻¹ (ND₂/ND) when the arrangement pitch of the pixels 12 in the second direction is ND₂. By satisfying the expression, the positional relationship between the pixels 12 and the light transmission sections 331 of the parallax barrier 330 facing the pixels is the same in the direction of the axial line AX of the parallax barrier 330 at all times, and thus it is possible to suppress the occurrence of crosstalk when stereoscopic display is performed and to thereby realize a high image quality stereoscopic display. Here, as illustrated in FIGS. 12 and 13, the light transmission sections 331 forming the parallax barrier 330 may be arranged in a straight line shape along the axial line AX of the parallax barrier 330. Alternatively, as illustrated in FIG. 14, the light transmission sections 331 forming the parallax barrier 330 may be arranged in a staircase pattern along the axial line AX of the parallax barrier 330. That is to say, a pin hole-shaped light transmission section (opening) is disposed so as to be obliquely connected, and thereby light transmission sections 331 which extend obliquely as a whole may be configured. The configuration and structure of the third embodiment may be applied to display apparatuses of the fourth and fifth embodiments described below.

### 5. Fourth Embodiment

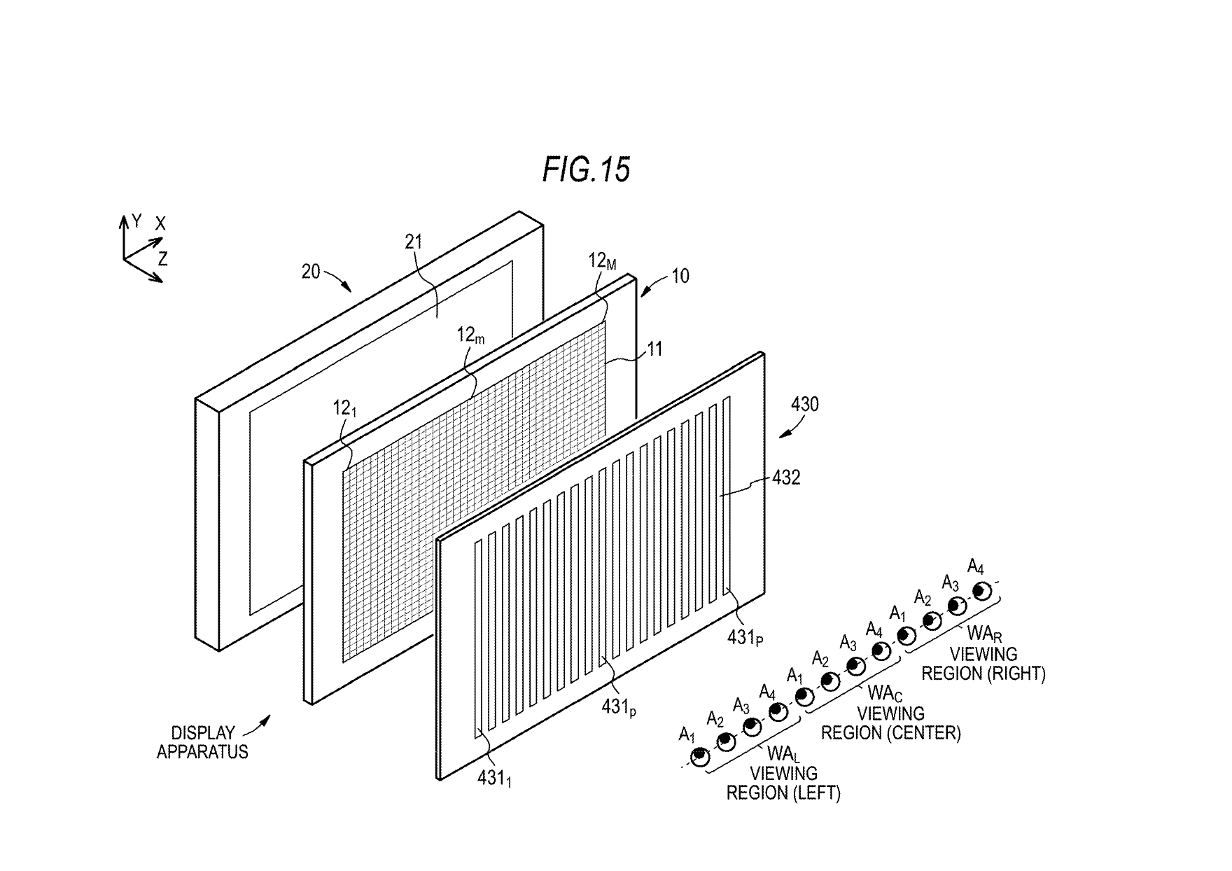

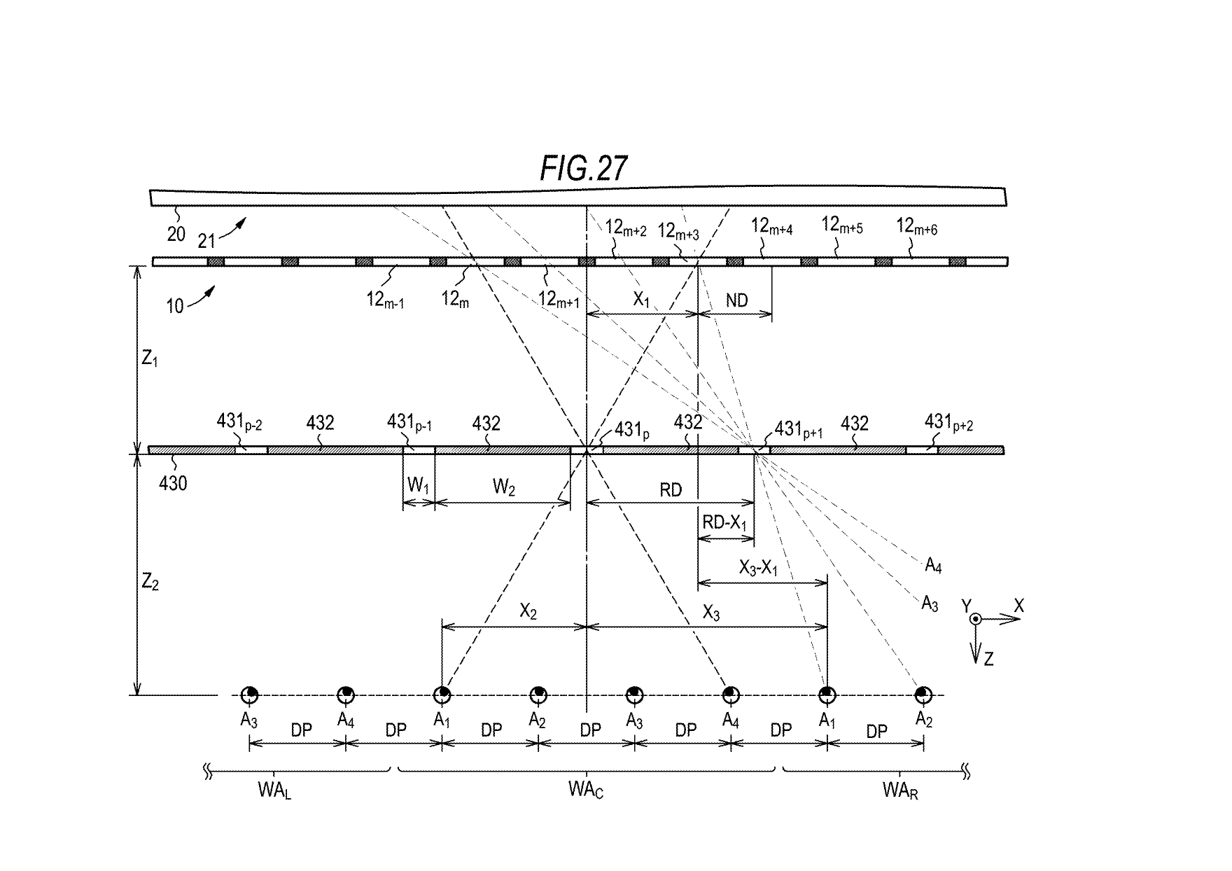

The fourth embodiment is also a modification of the first embodiment, but a display apparatus according to the fourth embodiment relates to, specifically, a so-called front barrier type display apparatus. FIG. 15 is a schematic perspective view when a display apparatus according to a fourth embodiment is virtually separated, and FIG. 27 is a conceptual diagram of the display apparatus illustrating a disposition relationship between a transmissive display panel 10, a parallax barrier 430, and a surface illumination device 20 in the display apparatus according to the fourth embodiment.

As illustrated in FIG. 15, in the display apparatus according to the fourth embodiment, the parallax barrier 430 is disposed on the front surface of the transmissive display panel 10. In addition, W₁ is changed to two values of W₁=α·ND and W₁=(α+1)·ND. In addition, 1<α<2 is satisfied. Specifically, in the fourth embodiment, α is set to 1.35. Except for the above-described matters, the configuration and structure of the display apparatus according to the fourth embodiment may be basically the same as the configuration and structure of the display apparatus according to the first embodiment.

In the fourth embodiment as well, a description will be made assuming that the number of viewpoints of images displayed on the display apparatus is four viewpoints A₁, A₂, A₃ and A₄ in the respective viewing regions WA_{L}, WA_{C} and WA_{R} illustrated in FIG. 15. However, the present disclosure is not limited thereto, and the number of viewing regions or viewpoints may be appropriately set according to designs of a display apparatus. FIG. 27 is a conceptual diagram illustrating a disposition relationship between the viewpoints A₁, A₂, A₃ and A₄ in the viewing regions WA_{L}, WA_{C} and WA_{R} illustrated in FIG. 15, the transmissive display panel 10, the parallax barrier 430, and the surface illumination device 20.

For convenience of description, it is assumed that the light transmission sections 431 are arranged in parallel in an odd number in the X direction, and the p-th light transmission section 431ₚ is located at the center between the light transmission section 431₁ and the light transmission section 431ₚ. In addition, it is assumed that a boundary between the m-th pixel 12ₘ and the (m+1)-th pixel 12ₘ₊₁, and a midpoint between the viewpoints A₂ and A₃ in the viewing region WA_{C} are located on a virtual straight line which extends through the center of the light transmission section 431ₚ in the Z direction.

A condition is examined in which the respective light beams from the pixels 12ₘ₊₃, 12ₘ₊₂, 12ₘ₊₁ and 12ₘ pass through the light transmission section 431ₚ and travel toward the viewpoints A₁, A₂, A₃ and A₄ of the central viewing region WA_{C}. For convenience of description, the description will be made assuming that the width W₁ of the light transmission section 431 is sufficiently small, and attention is paid to an orbit of light passing through the center of the light transmission sections 431. By using the virtual straight line extending through the center of the light transmission section 431ₚ in the Z direction as a reference, the distance to the center of the pixel 12ₘ₊₃ is indicated by X₁, and the distance to the viewpoint A₁ of the central viewing region WA_{C} is indicated by X₂. When light from the pixel 12ₘ₊₃ passes through the light transmission section 431ₚ and travels toward the viewpoint A₁ of the viewing region WA_{C}, a condition indicated by the following Expression (5) is satisfied from a geometric similarity relation.

Z₂/X₂=Z₂/X₂ (5)

Here, since X₂=1.5×ND and X₂=1.5×DP, if they are reflected, Expression (5) may be expressed as in the following Expression (5′).

Z₁/(1.5×ND)=Z₂/(1.5×DP) (5′)

In addition, if Expression (5′) is satisfied, it is geometrically clear that light beams from the pixels 12ₘ₊₂, 12ₘ₊₁ and 12ₘ passing through the light transmission section 431ₚ respectively travel toward the viewpoints A₂, A₃ and A₄ of the viewing region WA_{C}.

Next, a condition is examined in which the respective light beams from the pixels 12ₘ₋₁, 12ₘ, 12ₘ₊₁ and 12ₘ₊₂ pass through the light transmission section 431ₚ₊₁ and travel toward the viewpoints A₁, A₂, A₃ and A₄ of the right viewing region WA_{R}.

By using the virtual straight line extending through the center of the light transmission section 431ₚ₊₁ in the Z direction as a reference, the distance to the viewpoint A₁ of the right viewing region WA_{R} is indicated by X₃. In order for light from the pixel 12ₘ₊₃ to pass through the light transmission section 431ₚ₊₁ and travel toward the viewpoint A₁ of the viewing region WA_{R}, a condition indicated by the following Expression (6) is satisfied from a geometric similarity relation.

Z₁/(RD−X₁)=(Z₁+Z₂)/(X₃−X₁) (6)

Here, since X₁=1.5×ND and X₃=2.5×ND, if they are reflected, Expression (6) may be expressed as in the following Expression (6′).

Z₁/(RD−1.5×ND)=(Z₁+Z₂)/(2.5×DP−1.5×ND) (6′)

In addition, if Expression (6′) is satisfied, it is geometrically clear that light beams from the light transmission section 431ₚ₊₁ passing through the pixels 12ₘ₊₂, 12ₘ₊₁ and 12ₘ respectively travel toward the viewpoints A₂, A₃ and A₄ of the viewing region WA_{R}.

Values of the distance Z₂ and the distance DP are set to predetermined values on the basis of the specification of the display apparatus. In addition, the value of the pixel pitch ND is defined by the structure of the transmissive display panel 10. From Expressions (5′) and (6′), the following Expressions (7) and (8) can be obtained with respect to the distance Z₁ and the light transmission section pitch RD.

Z₁=Z₂×ND/DP (7)

RD=4×DP×ND/(DP+ND) (8)

In the above-described example, a value of the light transmission section pitch RD is substantially four times the value of the pixel pitch ND. Therefore, “M” and “P” have a relationship of M≅P×4. In addition, the distance Z₁ or the light transmission section pitch RD is set to satisfy the above-described conditions, and images for a predetermined viewpoint can be viewed at the respective viewpoints A₁, A₂, A₃ and A₄ of the viewing regions WA_{L}, WA_{C} and WA_{R}. For example, if the pixel pitch ND of the transmissive display panel 10 is 0.100 mm, the distance Z₂ is 1500 mm, and the distance DP is 65.0 mm, the distance Z₁ is 2.31 mm, and the light transmission section pitch RD is 0.399 mm.

Although the number of viewpoints is “four” in the above description, the number of viewpoints may be appropriately selected according to the specification of the display apparatus. For example, there may be a configuration where the number of viewpoints is “two”, or the number of viewpoints is “six”. In this case, the configuration of the parallax barrier 430 or the like may be appropriately changed. This is also the same for the fifth embodiment described later.

Further, in the display apparatus according to the fourth embodiment, as described above, when α is any coefficient equal to or more than 1, W₁ is changed to two values of W₁=α·ND and W₁=(α+1)·ND. Here, in the display apparatus according to the fourth embodiment, as described above, specifically, 1<α<2 is satisfied, and, more specifically, α=1.35. Further, in a case where great importance is placed on image quality in the display apparatus and great importance is not placed on luminance of an image, a form of W₁=α·ND may be employed, and, conversely, in a case where great importance is placed on luminance of an image in the display apparatus and great importance is not placed on image quality, a form of W₁=(α+1)·ND may be employed. By employing α=1.35, as described above, it is possible to suppress occurrence of moiré.

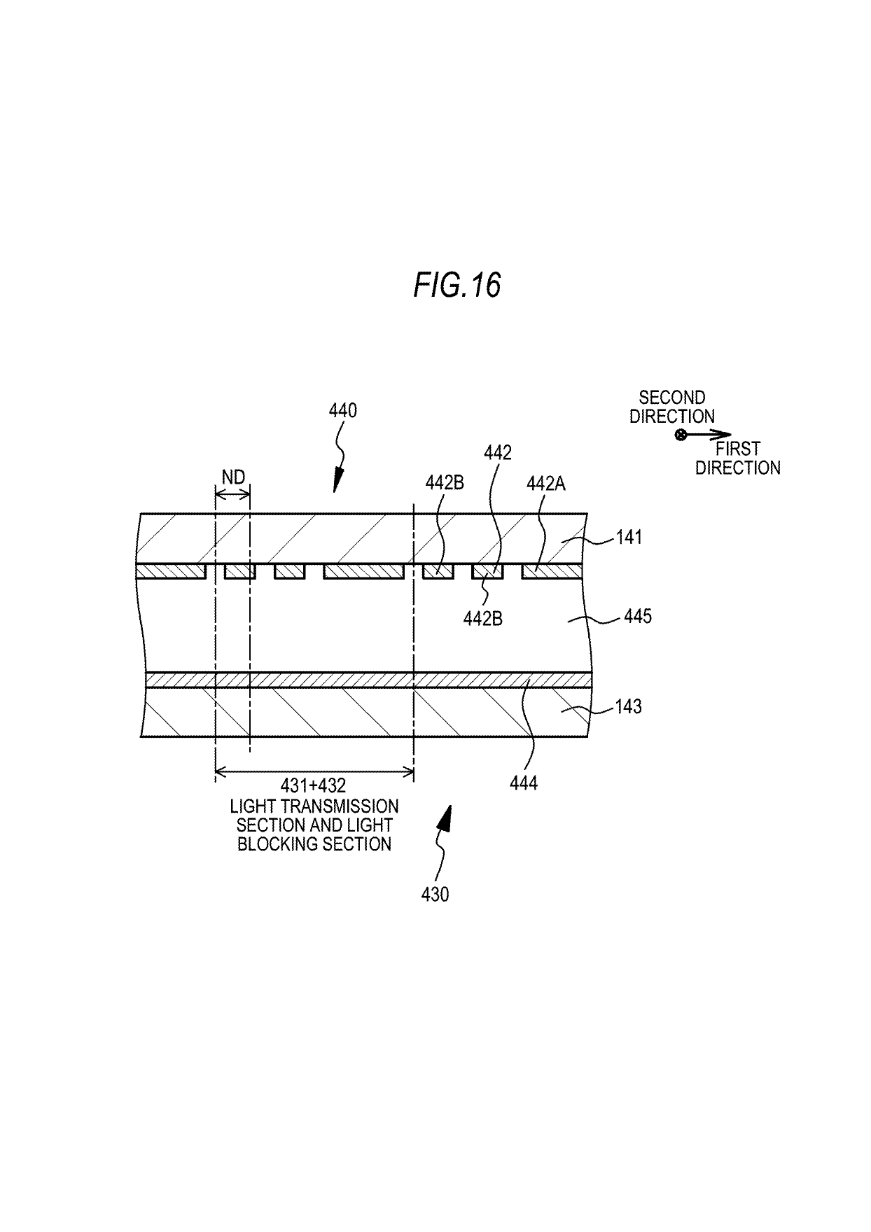

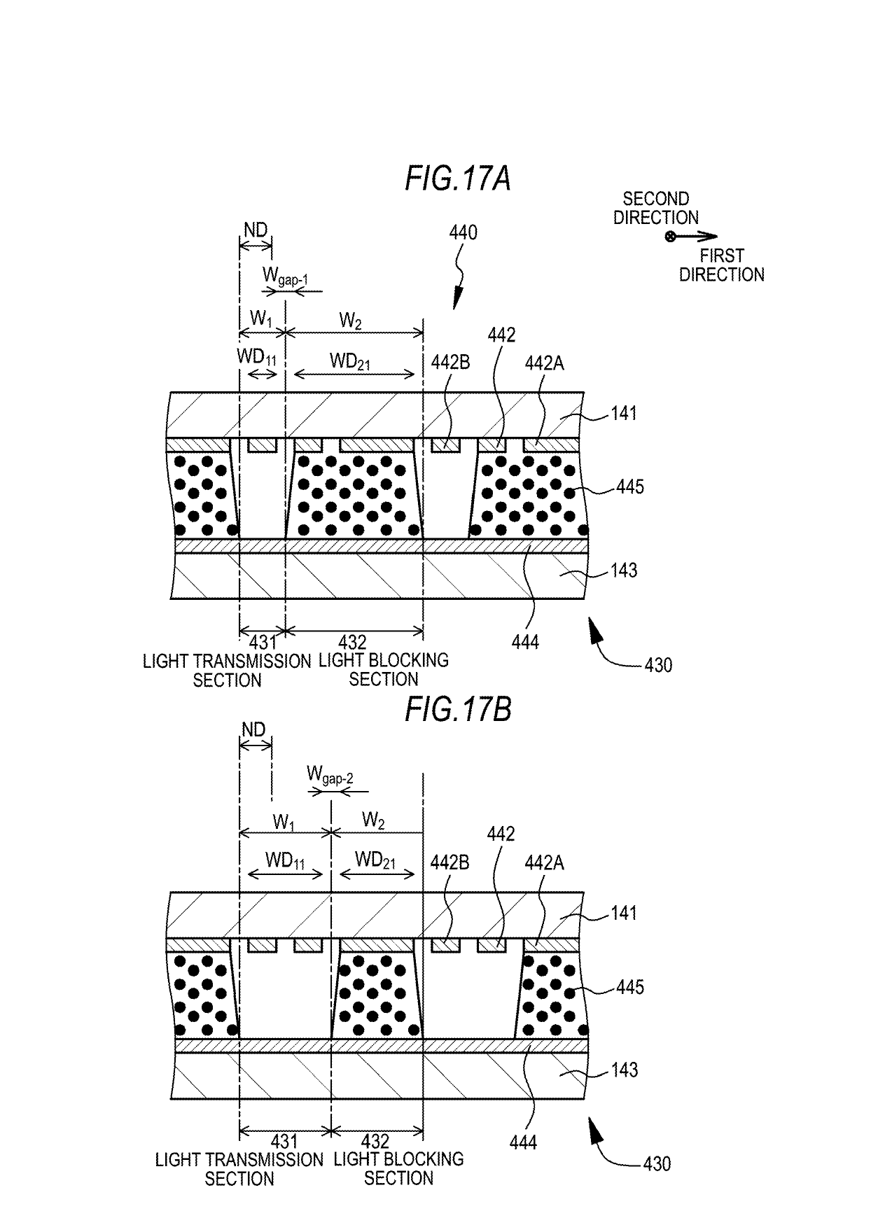

As illustrated in FIG. 16 and FIGS. 17A and 17B which are schematic partial cross-sectional views, in the fourth embodiment as well, in the liquid crystal display device 440 forming the parallax barrier 430, a set of the light transmission section 431 and the light blocking section 432 includes a first electrode 442A forming a single light blocking section 432 and two first electrode 442B forming the light transmission section 431. Further, in a case where the width W₁ of the light transmission section 431 in the first direction is [α·ND] (a first case), the light transmission section 431 includes a single first electrode 442B, and the light blocking section 432 includes a single first electrode 442A and the one remaining first electrode 442B. On the other hand, in a case where the width W₁ of the light transmission section 431 in the first direction is [(α+1)·ND] (a second case), the light transmission section 431 includes two first electrodes 442B, and the light blocking section 432 includes a single first electrode 442A. Here, the width WD₂₁ in the first direction of the first electrode 442A forming the light blocking section 432 is smaller than the width W₂ of the light blocking section 432 in the first direction, and, the width WD₁₁ in the first direction of the first electrode 442B forming the light transmission section 431 is smaller than the width W₁ of the light transmission section in the first direction. Specifically, in the first case, W₂−WD₂₁=10 μm, and W₁−WD₁₁=10 μm (refer to FIG. 17A). In addition, in the second case as well, W₂−WD₂₁=10 μm, and W₁−WD₁₁=10 μm (refer to FIG. 17B). Further, the gap width W_{gap-1} between the first electrode 442B and the first electrode 442B, and the gap width W_{gap-2} between the first electrode 442A and the first electrode 442B are W_{gap-1}=10 μm, and W_{gap-2}=10 μm. The width W₁ of the light transmission section in the first direction is changed to either [α·ND] or [(α+1)·ND] depending on the application state of a voltage to the first electrode 442 and the second electrode 444 (refer to FIGS. 17A and 17B). The width W₁ of the light transmission section is changed, and thereby it is possible to increase the luminance of an image displayed on the transmissive display panel 10. The liquid crystal layer 445 of the liquid crystal display device 440 forming the parallax barrier 430 may be in a state (normally white) of transmitting light therethrough or in a state (normally black) of not transmitting light therethrough when a voltage is not applied to the first electrode 442 and the second electrode 444. In addition, in the state of the liquid crystal display device 440 illustrated in FIG. 16, a two-dimensional image can be displayed.

Specifically, as described above, if the pixel pitch ND of the transmissive display panel 10 is 0.100 mm, the distance Z₂ is 1500 mm, and the distance DP is 65.0 mm, the distance Z₁ is 2.31 mm, and the light transmission section pitch RD is 0.399 mm. Here, W₁=0.135 mm, and W₂=0.264 mm, or, W₁=0.235 mm, and W₂=0.164 mm. In addition, W₁₁=0.125 mm, and W₂₁=0.225 mm.

In addition, in the fourth embodiment, the haze value of the parallax barrier 430 is 4%. Specifically, a film obtained by applying surface roughing treatment to a surface of a transparent film (not illustrated) such as a PET film or a TAC film, or a film in which particles having different refractive indices are sprayed may be bonded to the parallax barrier 430. This form may be applied to the embodiments described below.

In the display apparatus according to the fourth embodiment as well, stereoscopic images and two-dimensional images can be displayed, or different images can be displayed when the display apparatus is viewed from different angles. In addition, in the display apparatus according to the fourth embodiment as well, since the width of the light transmission section in the first direction is variable, in a case of making a request for high image quality of images displayed on the display apparatus, the width of the light transmission section may be small [W₁=α·ND], and, in a case of making a request for high luminance, the width of the light transmission section may be large [W₁=(α+1)·ND]. Therefore, it is possible to appropriately handle and support both the case of making a request for high image quality of images displayed on the display apparatus and the case of making a request for high luminance thereof.

### 6. Fifth Embodiment

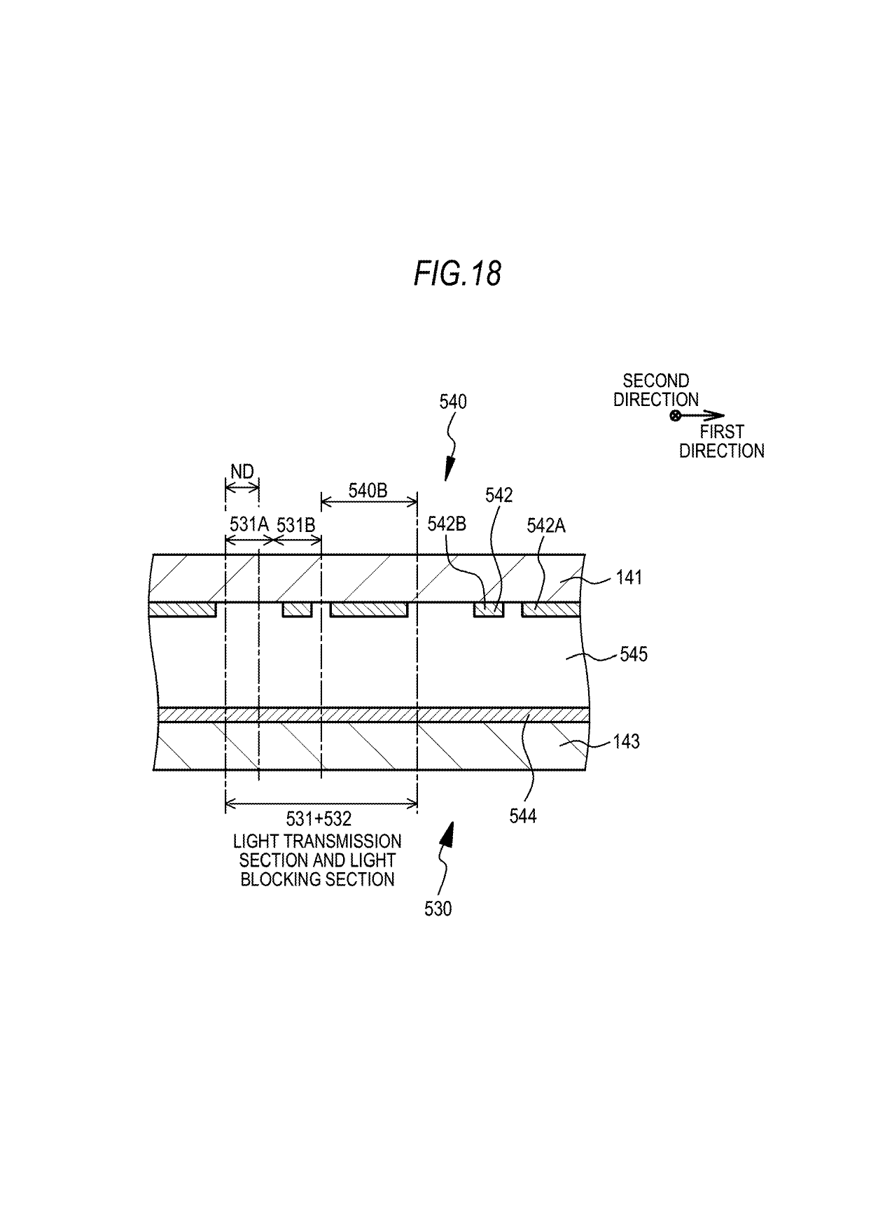

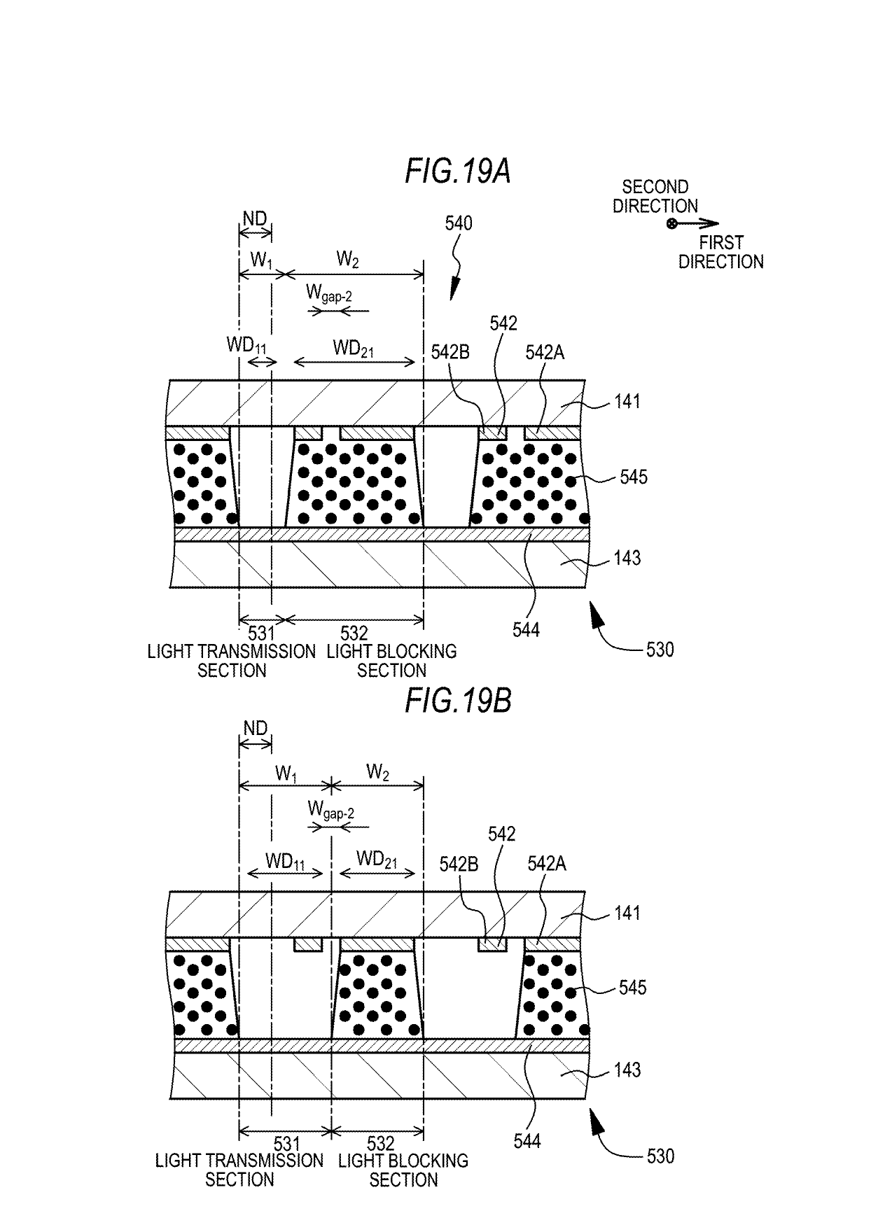

The fifth embodiment is a modification of the fourth embodiment. In the fifth embodiment, as illustrated in FIG. 18 and FIGS. 19A and 19B which are schematic partial cross-sectional views of a liquid crystal display device 540 forming a parallax barrier 530, a first electrode 542A is formed in a region 540B of the liquid crystal display device forming a light blocking section 532. In addition, a light transmission section 531 includes a region 531B in which the first electrode 542B is formed and a region 531A in which the first electrode is not formed, which are arranged in parallel in the first direction. Further, in a case where the width W₁ of the light transmission section 531 in the first direction is [α·ND] (a first case), the light transmission section 531 includes the region 531A in which the first electrode is not formed, and the light blocking section 532 includes the first electrode 542A and the first electrode 542B. On the other hand, in a case where the width W₁ of the light transmission section 531 in the first direction is [(α+1)·ND] (a “second case”), the light transmission section 531 includes the region 531B in which the first electrode 542B is formed and the region 531A in which the first electrode is not formed, and the light blocking section 532 includes the first electrode 542A. Here, the width WD₁₁ in the first direction of the first electrode 542B forming the light transmission section 531 is smaller than the width W₁ of the light transmission section 531 in the first direction. Specifically, in the first case, W₁−WD₁₁=10 μm (refer to FIG. 19A). In addition, in the second case as well, W₁−WD₁₁=10 μm (refer to FIG. 19B). Further, the gap width W_{gap-2} between the first electrode 542A and the first electrode 542B is the same as in the fourth embodiment. The liquid crystal layer 545 of the liquid crystal display device 540 forming the parallax barrier 530 is in a state (normally white) of transmitting light therethrough when a voltage is not applied to the first electrode 542 and the second electrode 544. In addition, in the fifth embodiment as well, the width W₁ of the light transmission section 531 in the first direction is changed to either W₁=α·ND or W₁=(α+1)·ND depending on the application state of a voltage to the first electrode 542 and the second electrode 544 (refer to FIGS. 19A and 19B). The width W₁ of the light transmission section is changed, and thereby it is possible to increase the luminance of an image displayed on the transmissive display panel 10. In addition, in the state of the liquid crystal display device 540 illustrated in FIG. 18, a two-dimensional image can be displayed.

As above, although the present disclosure has been described based on the embodiments, the present disclosure is not limited to the embodiments. The configurations and structures of the transmissive display panel, the surface illumination device, and the parallax barrier described in the embodiments are examples and may be appropriately modified. There is a transmissive display panel in which a black matrix with a large width is formed every two subpixels, such as, for example, the width of the black matrix in the first direction being large, small, large, small, . . . . In other words, the black matrix has a period structure of two subpixels. In a display apparatus having such a transmissive display panel, for example, in the display apparatus according to the first embodiment, a value of α may be twice the value of α described in each embodiment.

In addition, the present disclosure may be implemented as the following configurations. In one example configuration, a display apparatus includes a transmissive display panel that includes pixels arranged in a two-dimensional matrix in a first direction and a second direction different from the first direction; and a parallax barrier that separates images displayed on the transmissive display panel into images for a plurality of viewpoints, wherein the parallax barrier and the transmissive display panel are disposed so as to be opposite to each other with a space of a predetermined gap, wherein the parallax barrier includes a plurality of light transmission sections and light blocking sections which extend along an axial line parallel to the second direction or an axial line forming an acute angle with the second direction and are alternately arranged in parallel in the first direction, and wherein a width of the light transmission section in the first direction is variable.

The parallax barrier may have a liquid crystal display device at least including a first substrate; a first electrode formed and patterned on the first substrate; a second substrate disposed so as to be opposite to the first substrate; a second electrode formed on the second substrate so as to be opposite to the first electrode; and a liquid crystal layer interposed between the first substrate and the second substrate.

The display apparatus may include a surface illumination device that irradiates the transmissive display panel from a back surface, wherein the parallax barrier is disposed between the transmissive display panel and the surface illumination device.

If a width of the light transmission section in the first direction is W1, an arrangement pitch of the pixels in the first direction is ND, and α is any coefficient, then W1 may be changed to two values of W1=α·ND and the W1=2α·ND. Further, 0.95≦α≦1.05 may be satisfied. A haze value of the transmissive display panel may be 15% or less. The parallax barrier may, for example, be disposed on a front surface of the transmissive display panel.

If a width of the light transmission section in the first direction is W1, an arrangement pitch of the pixels in the first direction is ND, and α is any coefficient equal to or more than 1, then W1 may be changed to two values of W1=α·ND and the W1=(α+1)·ND. Further, 1<α<2 may be satisfied. A haze value of the parallax barrier may be 15% or less.

A width in the first direction of the first electrode forming the light blocking section may, for example, be smaller than a width of the light blocking section in the first direction. A width in the first direction of the first electrode forming the light transmission section may be smaller than a width of the light transmission section in the first direction.

A width of the light transmission section in the first direction may vary depending on the state of a voltage to the first electrode and the second electrode.

The first electrode may be formed in a region of a liquid crystal display device forming the light blocking section, the light transmission sections may include a region in which the first electrode is formed and a region in which the first electrode is not formed, which may be arranged in parallel in the first direction, and a width in the first direction of the first electrode forming the light transmission section may be smaller than a width of the light transmission section in the first direction. A width of the light transmission section in the first direction may vary depending on an application state of a voltage to the first electrode and the second electrode.

An angle θ formed by the axial line of the parallax barrier and the second direction may be an acute angle, and θ=tan−1(ND2/ND) may be satisfied when an arrangement pitch of the pixels in the second direction is ND2.

An angle θ formed by the axial line of the parallax barrier and the second direction may be an acute angle, and the light transmission sections forming the parallax barrier may be arranged in a straight line shape along the axial line of the parallax barrier.

An angle θ formed by the axial line of the parallax barrier and the second direction may be an acute angle, and the light transmission sections forming the parallax barrier may be arranged in a staircase pattern along the axial line of the parallax barrier.

In another example configuration, a display apparatus comprises: a display panel, comprising a plurality of pixels; and a parallax barrier, comprising a plurality of light transmission sections and a plurality of light blocking sections; wherein the display apparatus is operable to switch between a first setting in which at least one of the plurality of light transmission sections has a first width and a second setting in which the at least one of the plurality of light transmission sections has a second width different than the first width.

The plurality of pixels may be arranged in an array along a first direction and a second direction. Each of the plurality of pixels may have a center, a distance measured in the first direction between the centers of two pixels may define a pixel pitch of the display panel, and the second width may exceed the pixel pitch.

The pixel pitch of the display panel may be ND, α may be any coefficient, the first width may be a product of ND and α, and the second width may be a product of ND and 2α.

The pixel pitch of the display panel may be ND, α may be any coefficient greater than or equal to 1, the first width may be a product of ND and α, and the second width may be a product of ND and (α+1).

The first direction may be substantially horizontal, and the second direction may be substantially vertical.

At least some of the plurality of light transmission sections may have a length extending along an axial line substantially parallel to the second direction, or at an acute angle to the second direction.

The parallax barrier may comprise a first electrode and a second electrode, and the display apparatus may be operable to switch between the first setting and the second setting via an application of a voltage to the first electrode and the second electrode. At least one of the light blocking sections may reside in a region of the parallax barrier in which the first electrode is formed, the at least one light transmission section may comprise a first portion residing in a region of the parallax barrier in which the first electrode is formed and a second portion residing in a region of the parallax barrier in which the first electrode is not formed, and the width of the at least one light transmission section may vary depending on the application of the voltage to the first electrode and the second electrode.

The display apparatus may comprise a changeover switch operable by a user to switch the display apparatus between the first setting and the second setting.

The display apparatus may comprise an image signal processing unit operable to switch the display apparatus between the first setting and the second setting based on an analysis of image data.

The display panel may comprise a transmissive display panel. The display apparatus may comprise a surface illumination device to irradiate the transmissive display panel with light, and the parallax barrier may reside between the surface illumination device and the transmissive display panel.

The display panel may be viewable from a viewing location, and the parallax barrier may reside between the display panel and the viewing location.

The plurality of light blocking sections may define images visible from each of a plurality of viewpoints.

The parallax barrier and the display panel may be separated by a gap.

The display apparatus may, for example, comprise a stereoscopic image display apparatus. If so, the display apparatus may comprise a naked eye type stereoscopic image display apparatus. In yet another example configuration, an electronic device comprises: a display panel, comprising a plurality of pixels; and a parallax barrier, comprising a plurality of light transmission sections and a plurality of light blocking sections; wherein the electronic device is operable to switch between a first setting in which at least one of the plurality of light transmission sections has a first width and a second setting in which the at least one of the plurality of light transmission sections has a second width different than the first width.

The present disclosure contains subject matter related to that disclosed in Japanese Priority Patent Application JP 2012-000624 filed in the Japan Patent Office on Jan. 5, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

1. A display apparatus, comprising:
a display panel, comprising a plurality of pixels;
a parallax barrier, comprising a plurality of light transmission sections and a plurality of light blocking sections;
wherein the display apparatus is operable to switch between a first setting in which at least one of the plurality of light transmission sections has a first width and a second setting in which the at least one of the plurality of light transmission sections has a second width different than the first width.

2. The display apparatus of claim 1, wherein the plurality of pixels are arranged in an array along a first direction and a second direction, each of the plurality of pixels has a center, a distance measured in the first direction between the centers of two pixels defines a pixel pitch of the display panel, and the second width exceeds the pixel pitch.

3. The display apparatus of claim 2, wherein the pixel pitch of the display panel is ND, α is any coefficient, the first width is a product of ND and α, and the second width is a product of ND and 2α.

4. The display apparatus of claim 2, wherein the pixel pitch of the display panel is ND, α is any coefficient greater than or equal to 1, the first width is a product of ND and α, and the second width is a product of ND and (α+1).

5. The display apparatus of claim 2, wherein the first direction is substantially horizontal, and the second direction is substantially vertical.

6. The display apparatus of claim 5, wherein at least some of the plurality of light transmission sections have a length extending along an axial line substantially parallel to the second direction, or at an acute angle to the second direction.

7. The display apparatus of claim 2, wherein the parallax barrier comprises a first electrode and a second electrode, and the display apparatus is operable to switch between the first setting and the second setting via an application of a voltage to the first electrode and the second electrode.

8. The display apparatus of claim 7, wherein at least one of the light blocking sections resides in a region of the parallax barrier in which the first electrode is formed, the at least one light transmission section comprises a first portion residing in a region of the parallax barrier in which the first electrode is formed and a second portion residing in a region of the parallax barrier in which the first electrode is not formed, and the width of the at least one light transmission section varies depending on the application of the voltage to the first electrode and the second electrode.

9. The display apparatus of claim 1, comprising a changeover switch operable by a user to switch the display apparatus between the first setting and the second setting.

10. The display apparatus of claim 1, comprising an image signal processing unit operable to switch the display apparatus between the first setting and the second setting based on an analysis of image data.

11. The display apparatus of claim 1, wherein the display panel is a transmissive display panel.

12. The display apparatus of claim 11, comprising a surface illumination device to irradiate the transmissive display panel with light, and wherein the parallax barrier resides between the surface illumination device and the transmissive display panel.

13. The display apparatus of claim 1, wherein the display panel is viewable from a viewing location, and wherein the parallax barrier resides between the display panel and the viewing location.

14. The display apparatus of claim 1, wherein the plurality of light blocking sections define images visible from each of a plurality of viewpoints.

15. The display apparatus of claim 1, wherein the parallax barrier and the display panel are separated by a gap.

16. The display apparatus of claim 1, comprising a stereoscopic image display apparatus.

17. The display apparatus of claim 16, comprising a naked eye type stereoscopic image display apparatus.

18. An electronic device, comprising:
a display panel, comprising a plurality of pixels;
a parallax barrier, comprising a plurality of light transmission sections and a plurality of light blocking sections;
wherein the electronic device is operable to switch between a first setting in which at least one of the plurality of light transmission sections has a first width and a second setting in which the at least one of the plurality of light transmission sections has a second width different than the first width.
